(19) United States
(12) Patent Application Publication
(10) Pub. No.: US 2019/0097268 A1
(43) Pub. Date: Mar. 28, 2019

(54) SOLID ELECTROLYTE COMPOSITION, SOLID ELECTROLYTE-CONTAINING SHEET, ELECTRODE SHEET FOR ALL-SOLID STATE SECONDARY BATTERY, ALL-SOLID STATE SECONDARY BATTERY, AND METHODS FOR MANUFACTURING SOLID ELECTROLYTE-CONTAINING SHEET, ELECTRODE SHEET FOR ALL-SOLID STATE SECONDARY BATTERY, AND ALL-SOLID STATE SECONDARY BATTERY

(71) Applicant: FUJIFILM Corporation, Tokyo (JP)

(72) Inventors: Tomonori Mimura, Ashigarakami-gun (JP); Hiroaki Mochizuki, Ashigarakami-gun (JP); Masaomi Makino, Ashigarakami-gun (JP)

(73) Assignee: FUJIFILM Corporation, Tokyo (JP)

(21) Appl. No.: 16/206,153

(22) Filed: Nov. 30, 2018

Related U.S. Application Data
(63) Continuation of application No. PCT/JP2017/020414, filed on Jun. 1, 2017.

(30) Foreign Application Priority Data
Jun. 3, 2016 (JP) 2016-112243
May 29, 2017 (JP) 2017-105406

(51) Int. Cl. H01M 10/0562; H01M 10/0585; H01M 4/02

(52) U.S. Cl. CPC H01M 10/0562; H01M 10/0585; H01M 4/02; C08L 33/08; H01M 2004/027; H01M 2004/028; C08L 2203/20; H01M 2300/0068

(57) ABSTRACT

Provided are a solid electrolyte composition including an inorganic solid electrolyte (A) having conductivity of an ion of a metal belonging to Group I or II of a periodic table, a dispersion medium (B) having a Log P value of 1.2 or less, and a dispersion medium (C) having a Log P value of 2 or more, in which a mass ratio (C)/(B) of the dispersion medium (C) to the dispersion medium (B) is 100,000≥(C)/(B)≥10, a solid electrolyte-containing sheet, an all-solid state secondary battery, and methods for manufacturing a solid electrolyte-containing sheet and an all-solid state secondary battery.

### CROSS-REFERENCE TO RELATED APPLICATIONS

This application is a Continuation of PCT International Application No. PCT/JP2017/020414 filed on Jun. 1, 2017, which claims priorities under 35 U.S.C. § 119 (a) to Japanese Patent Application No. 2016-112243 filed in Japan on Jun. 3, 2016 and Japanese Patent Application No. 2017-105406 filed in Japan on May 29, 2017. Each of the above applications is hereby expressly incorporated by reference, in its entirety, into the present application.

### BACKGROUND OF THE INVENTION

### 1. Field of the Invention

The present invention relates to a solid electrolyte composition, a solid electrolyte-containing sheet, an electrode sheet for an all-solid state secondary battery, an all-solid state secondary battery, and methods for manufacturing a solid electrolyte-containing sheet, an electrode sheet for an all-solid state secondary battery, and an all-solid state secondary battery.

### 2. Description of the Related Art

A lithium ion secondary battery is a storage battery which has a negative electrode, a positive electrode and an electrolyte sandwiched between the negative electrode and the positive electrode and enables charging and discharging by the reciprocal migration of lithium ions between both electrodes. In the related art, in lithium ion secondary batteries, an organic electrolytic solution has been used as the electrolyte. However, in organic electrolytic solutions, liquid leakage is likely to occur, there is a concern that a short circuit and ignition may be caused in batteries due to overcharging or overdischarging, and there is a demand for additional improvement in reliability and safety.

Under such circumstances, all-solid state secondary batteries in which an inorganic solid electrolyte is used instead of the organic electrolytic solution are attracting attention. In all-solid state secondary batteries, all of the negative electrode, the electrolyte, and the positive electrode are solid, safety and reliability which are considered as a problem of batteries in which the organic electrolytic solution is used can be significantly improved, and it also becomes possible to extend service lives. Furthermore, all-solid state secondary batteries can be provided with a structure in which the electrodes and the electrolyte are directly disposed in series. Therefore, it becomes possible to increase the energy density to be higher than that of secondary batteries in which the organic electrolytic solution is used, and the application to electric vehicles, large-sized storage batteries, and the like is anticipated.

Due to the respective advantages described above, as next-generation lithium ion batteries, development of all-solid state secondary batteries, manufacturing methods thereof, or slurries that are used to manufacture all-solid state secondary batteries is underway. For example, JP2012-243472A describes a method for manufacturing an all-solid state secondary battery which maintains flexibility even after a long period of storage and is constituted of a green sheet exhibiting a high mechanical strength. In this method for manufacturing an all-solid state secondary battery, in a slurry that is used to form the green sheet, two kinds of solvents having different boiling points are used. In addition, JP2012-212652A describes a slurry that can be used to produce an all-solid state secondary battery having a great charge and discharge capacity and a great output. This slurry contains a sulfide solid electrolyte material and a dispersion medium made of at least one of a ternary amine; an ether; a thiol; an ester having a functional group having 3 or more carbon atoms which is bonded to a carbon atom in an ester group and a functional group having 4 or more carbon atoms which is bonded to an oxygen atom in an ester group; or an ester having a benzene ring bonded to a carbon atom in an ester group.

### SUMMARY OF THE INVENTION

Due to the anticipated future prospects, all-solid state secondary batteries are being rapidly put into practical use. In response to all-solid state secondary batteries being put into practical use, there is a demand for, particularly, the suppression of resistance and the improvement of cycle characteristics at a higher level.

As described above, in the case of employing the method for manufacturing an all-solid state secondary battery described in JP2012-243472A or using the slurry described in JP2012-212652A, it is considered that all-solid state secondary batteries having desired performance can be obtained. However, in the inventions described in the respective patent documents described above, the improvement of a low resistance property and cycle characteristics which is demanded for all-solid state secondary batteries is not sufficiently studied.

Therefore, an object of the present invention is to provide a solid electrolyte composition which enables the obtainment of an all-solid state secondary battery in which the resistance is sufficiently suppressed and the cycle characteristics are excellent in the case of being used to manufacture the all-solid state secondary battery. In addition, another object of the present invention is to provide a solid electrolyte-containing sheet and an electrode sheet for an all-solid state secondary battery which are produced using a solid electrolyte composition having the above-described performance. In addition, still another object of the present invention is to provide an all-solid state secondary battery in which the resistance is sufficiently suppressed and the cycle characteristics are excellent. Furthermore, far still another object of the present invention is to provide methods for manufacturing the solid electrolyte-containing sheet, the electrode sheet for an all-solid state secondary battery, and the all-solid state secondary battery.

As a result of intensive studies, the present inventors found that, in a solid electrolyte composition which contains a specific inorganic solid electrolyte and contains two kinds of dispersion media having Log P values that are different from each other and in a specific range at a specific mass ratio, the solubility of the inorganic solid electrolyte is appropriately controlled, and the dispersion stability is excellent and found that, in the case of using the above-described solid electrolyte composition, an all-solid state secondary battery in which the resistance is sufficiently suppressed and the cycle characteristics are excellent can be obtained.

The present invention was completed by repeating additional studies on the basis of the above-described finding.

That is, the above-described objects are achieved by the following means.

<1> A solid electrolyte composition comprising: an inorganic solid electrolyte (A) having conductivity of an ion of a metal belonging to Group I or II of a periodic table; a dispersion medium (B) having a Log P value of 1.2 or less; and a dispersion medium (C) having a Log P value of 2 or more, in which a mass ratio (C)/(B) of the dispersion medium (C) to the dispersion medium (B) is 100,000≥(C)/(B)≥10.

<2> The solid electrolyte composition according to <I>, in which the Log P value of the dispersion medium (B) is 0.2 or more.

<3> The solid electrolyte composition according to <1> or <2>, in which the mass ratio (C)/(B) is 1,000≥(C)/(B)≤50.

<4> The solid electrolyte composition according to any one of <1> to <3>, in which the dispersion medium (B) is a ketone compound, a nitrile compound, a halogen-containing compound, a heterocyclic compound in which a hetero atom constituting a ring is a nitrogen atom or a sulfur atom, or a carbonate compound.

<5> The solid electrolyte composition according to any one of <1> to <4>, in which the dispersion medium (B) is a ketone compound, a heterocyclic compound in which a hetero atom constituting a ring is a nitrogen atom or a sulfur atom, or a halogen-containing compound, and the dispersion medium (C) is a hydrocarbon compound or an aromatic compound.

<6> The solid electrolyte composition according to any one of <1> to <5>, in which the dispersion medium (B) is a heterocyclic compound in which a hetero atom constituting a ring is a nitrogen atom or a sulfur atom.

<7> The solid electrolyte composition according to any one of <1> to <6>, in which the dispersion medium (B) and the dispersion medium (C) are evenly mixed together in the case of being mixed together at the mass ratio.

<8> The solid electrolyte composition according to any one of <1> to <7>, further comprising: a polymer particle (D).

(9) The solid electrolyte composition according to any one of <1> to <8>, in which the inorganic solid electrolyte (A) is represented by Formula (1).

Lₐ₁M_{b1}P_{c1}S_{d1}Aₑ₁ Formula (1)

In the formula, L represents an element selected from Li, Na, and K. M represents an element selected from B, Zn, Sn, Si, Cu, Ga, Sb, Al, and Ge. A represents I, Br, Cl, or F. a1 to e1 represent compositional ratios of the respective elements, and a1:b1:c1:d1:e1 satisfies 1 to 12:0 to 5:1:2 to 12:0 to 10.

<10> The solid electrolyte composition according to <8>, in which the polymer particle (D) is insoluble in the dispersion medium (B) and the dispersion medium (C).

<11> The solid electrolyte composition according to any one of <1> to <10>, further comprising: an active material (E) capable of inserting and discharging the ion of the metal belonging to Group I or II of the periodic table.

<12> The solid electrolyte composition according to <11>, in which the active material (E) is a metal oxide.

<13> The solid electrolyte composition according to any one of <1> to <12>, further containing: a conductive auxiliary agent.

<14> The solid electrolyte composition according to any one of <1> to <13>, further containing: a lithium salt.

<15> The solid electrolyte composition according to any one of <1> to <14>, further containing: an ionic liquid.

<16> A solid electrolyte-containing sheet comprising, on a base material: an applied and dried layer of the solid electrolyte composition according to any one of <1> to <15>.

<17> An electrode sheet for an all-solid state secondary battery, comprising, on a metal foil: an applied and dried layer of the solid electrolyte composition according to <11> or <12>.

<18> An all-solid state secondary battery comprising: a positive electrode active material layer; a negative electrode active material layer; and a solid electrolyte layer, in which at least one of the positive electrode active material layer, the negative electrode active material layer, or the solid electrolyte layer is an applied and dried layer of the solid electrolyte composition according to any one of <1> to <15>.

<19> A method for manufacturing a solid electrolyte-containing sheet, comprising: a step of disposing the solid electrolyte composition according to any one of <1> to <15> on a base material and forming a coated film.

<20> A method for manufacturing an electrode sheet for an all-solid state secondary battery, comprising: a step of disposing the solid electrolyte composition according to <11> or <12> on a metal foil and forming a coated film.

<21> A method for manufacturing an all-solid state secondary battery, in which an all-solid state secondary battery is manufactured through the manufacturing method according to <19> or <20>.

In the present specification, numerical ranges expressed using “to” include numerical values before and after the “to” as the lower limit value and the upper limit value.

In the present specification, “acrylic” or “(meth)acrylic” that is simply expressed is used to refer to methacrylic and/or acrylic. In addition, “acryloyl” or “(meth)acryloyl” that is simply expressed is used to refer to methacryloyl and/or acryloyl.

The solid electrolyte composition of the embodiment of the invention is excellent in terms of dispersion stability and enables the obtainment of an all-solid state secondary battery in which the resistance is sufficiently suppressed and the cycle characteristics are excellent in the case of being used to manufacture the all-solid state secondary battery. The solid electrolyte-containing sheet and the electrode sheet for an all-solid state secondary battery of the embodiment of the invention are excellent in terms of a binding property and an ion conductivity. In addition, in the all-solid state secondary battery of the embodiment of the invention, the resistance is sufficiently suppressed and the cycle characteristics are excellent.

In addition, according to the manufacturing methods of the embodiment of the invention, it is possible to manufacture the solid electrolyte-containing sheet, the electrode sheet for an all-solid state secondary battery, and the all-solid state secondary battery of the embodiment of the invention.

The above-described and other characteristics and advantages of the present invention will be further clarified by the following description with appropriate reference to the accompanying drawings.

### BRIEF DESCRIPTION OF THE DRAWINGS

FIG. 1 is a vertical cross-sectional view schematically illustrating an all-solid state secondary battery according to a preferred embodiment of the present invention.

FIG. 2 is a vertical cross-sectional view schematically illustrating an all-solid state secondary battery (coin battery) produced in examples.

### DESCRIPTION OF THE PREFERRED EMBODIMENTS

### Preferred Embodiment

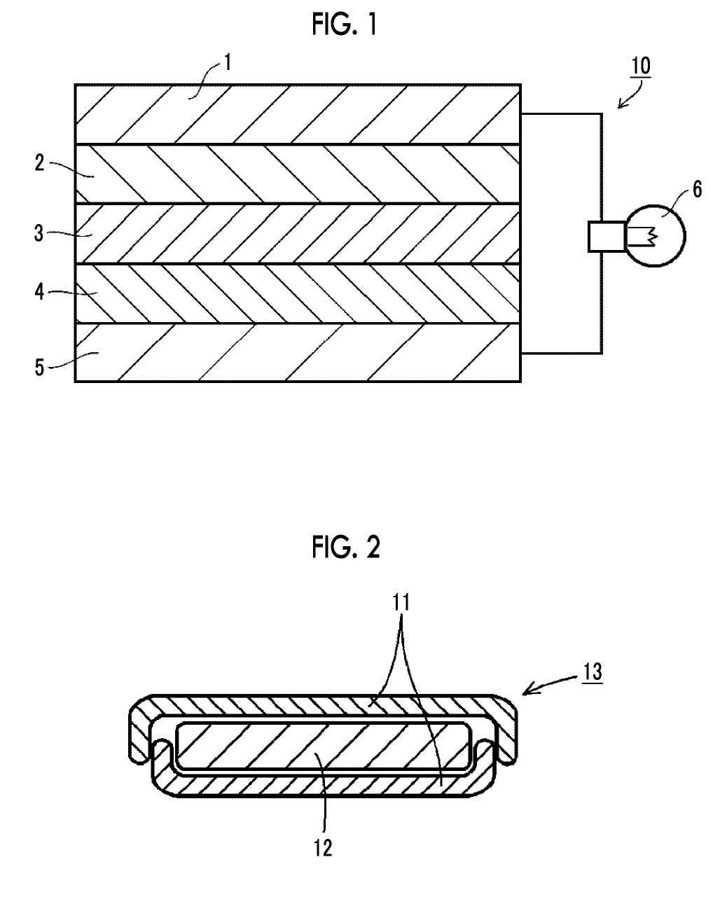

FIG. 1 is a cross-sectional view schematically illustrating an all-solid state secondary battery (lithium ion secondary battery) according to a preferred embodiment of the present invention. In the case of being seen from the negative electrode side, an all-solid state secondary battery 10 of the present embodiment has a negative electrode collector 1, a negative electrode active material layer 2, a solid electrolyte layer 3, a positive electrode active material layer 4, and a positive electrode collector 5 in this order. The respective layers are in contact with one another and have a laminated structure. In a case in which the above-described structure is employed, during charging, electrons (e⁻) are supplied to the negative electrode side, and lithium ions (Li⁺) are accumulated on the negative electrode side. On the other hand, during discharging, the lithium ions (Li⁺) accumulated on the negative electrode side return to the positive electrode, and electrons are supplied to an operation portion 6. In an example illustrated in the drawing, an electric bulb is employed as the operation portion 6 and is lit by discharging. A solid electrolyte composition of the embodiment of the invention can be preferably used as a material used to shape the negative electrode active material layer, the positive electrode active material layer, and the solid electrolyte layer. In addition, a solid electrolyte-containing sheet of the embodiment of the invention is preferred as the negative electrode active material layer, the positive electrode active material layer, and the solid electrolyte layer.

In the present specification, the positive electrode active material layer (hereinafter, also referred to as the positive electrode layer) and the negative electrode active material layer (hereinafter, also referred to as the negative electrode layer) will be collectively referred to as the electrode layer or the active material layer in some cases.

Meanwhile, in a case in which an all-solid state secondary battery having the layer constitution illustrated in FIG. 1 is put into a 2032-type coin case, the all-solid state secondary battery having the layer constitution illustrated in FIG. 1 will be referred to as an electrode sheet for an all-solid state secondary battery, and a battery produced by putting this electrode sheet for an all-solid state secondary battery into a 2032-type coin case will be referred to as an all-solid state secondary battery, whereby the electrode sheet for an all-solid state secondary battery and the all-solid state secondary battery will be differentiated in some cases.

The thicknesses of the positive electrode active material layer 4, the solid electrolyte layer 3, and the negative electrode active material layer 2 are not particularly limited. Meanwhile, in a case in which the dimensions of ordinary batteries are taken into account, the thicknesses are preferably 10 to 1,000 μm and more preferably 20 μm or more and less than 500 μm. In the all-solid state secondary battery of the embodiment of the invention, the thickness of at least one layer of the positive electrode active material layer 4, the solid electrolyte layer 3, or the negative electrode active material layer 2 is still more preferably 50 μm or more and less than 500 μm.

<Solid Electrolyte Composition>

The solid electrolyte composition of the embodiment of the invention includes an inorganic solid electrolyte (A) having conductivity of an ion of a metal belonging to Group I or II of a periodic table, a dispersion medium (B) having a Log P value of 1.2 or less, and a dispersion medium (C) having a Log P value of 2 or more, and a mass ratio (C)/(B) of the dispersion medium (C) to the dispersion medium (B) is 100,000≥(C)/(B)≥10.

Hereinafter, components other than the dispersion medium (B) and the dispersion medium (C) which are included in the solid electrolyte composition of the embodiment of the invention will be referred to with no references attached thereto in some cases. For example, there will be cases in which the inorganic solid electrolyte (A) is simply referred to as the inorganic solid electrolyte.

(Inorganic Solid Electrolyte (A))

The inorganic solid electrolyte is an inorganic solid electrolyte, and the solid electrolyte refers to a solid-form electrolyte capable of migrating ions therein. The inorganic solid electrolyte is clearly differentiated from organic solid electrolytes (polymer electrolytes represented by polyethylene oxide (PEO) or the like and organic electrolyte salts represented by lithium bis(trifluoromethanesulfonyl)imide (LiTFSI)) since the inorganic solid electrolyte does not include any organic substances as a principal ion-conductive material. In addition, the inorganic solid electrolyte is a solid in a static state and is thus, generally, not disassociated or liberated into cations and anions. Due to this fact, the inorganic solid electrolyte is also clearly differentiated from inorganic electrolyte salts of which cations and anions are disassociated or liberated in electrolytic solutions or polymers (LiPF₆, LiBF₄, LiFSI, LiCl, and the like). The inorganic solid electrolyte is not particularly limited as long as the inorganic solid electrolyte has conductivity of an ion of a metal belonging to Group I or II of the periodic table and is generally a substance not having electron conductivity.

In the present invention, the inorganic solid electrolyte has conductivity of an ion of a metal belonging to Group I or II of the periodic table. As the inorganic solid electrolyte, it is possible to appropriately select and use solid electrolyte materials that are applied to this kind of products. Typical examples of the inorganic solid electrolyte include (i) sulfide-based inorganic solid electrolytes and (ii) oxide-based inorganic solid electrolytes. In the present invention, the sulfide-based inorganic solid electrolytes are preferably used since it is possible to form a more favorable interface between the active material and the inorganic solid electrolyte.

(i) Sulfide-Based Inorganic Solid Electrolytes

Sulfide-based inorganic solid electrolytes are preferably compounds which contain sulfur atoms (S), have ion conductivity of a metal belonging to Group I or II of the periodic table, and have electron-insulating properties. The sulfide-based inorganic solid electrolytes are preferably inorganic solid electrolytes which, as elements, contain at least Li, S, or P and have a lithium ion conductivity, but the sulfide-based inorganic solid electrolytes may also include elements other than Li, S, and P depending on the purposes or cases.

Examples thereof include lithium ion-conductive inorganic solid electrolytes satisfying a composition represented by Formula (1).

Lₐ₁M_{b1}P_{c1}S_{d1}Aₑ₁ Formula (1)

In the formula, L represents an element selected from Li, Na, and K and is preferably Li. M represents an element selected from B, Zn, Sn, Si, Cu, Ga, Sb, Al, and Ge. A represents an element selected from I, Br, Cl, and F. a1 to e1 represent the compositional ratios among the respective elements, and a1:b1:c1:d1:e1 satisfies 1 to 12:0 to 5:1:2 to 12:0 to 10. Furthermore, a1 is preferably 1 to 9 and more preferably 1.5 to 7.5. b1 is preferably 0 to 3 and more preferably 0 to 1. Furthermore, d1 is preferably 2.5 to 10 and more preferably 3.0 to 8.5. Furthermore, e1 is preferably 0 to 5 and more preferably 0 to 3.

The compositional ratios among the respective elements can be controlled by adjusting the amounts of raw material compounds blended to manufacture the sulfide-based inorganic solid electrolyte as described below.

The sulfide-based inorganic solid electrolytes may be non-crystalline (glass) or crystallized (made into glass ceramic) or may be only partially crystallized. For example, it is possible to use Li—P—S-based glass containing Li, P, and S or Li—P—S-based glass ceramic containing Li, P, and S.

The sulfide-based inorganic solid electrolytes can be manufactured by a reaction of at least two raw materials of, for example, lithium sulfide (Li₂S), phosphorus sulfide (for example, diphosphorus pentasulfide (P₂S₅)), a phosphorus single body, a sulfur single body, sodium sulfide, hydrogen sulfide, lithium halides (for example, LiI, LiBr, and LiCl), or sulfides of an element represented by M (for example, SiS₂, SnS, and GeS₂).

The ratio between Li₂S and P₂S₅ in Li—P—S-based glass and Li—P—S-based glass ceramic is preferably 60:40 to 90:10 and more preferably 68:32 to 78:22 in terms of the molar ratio between Li₂S:P₂S₅. In a case in which the ratio between Li₂S and P₂S₅ is set in the above-described range, it is possible to increase the lithium ion conductivity. Specifically, the lithium ion conductivity can be preferably set to 1×10⁻⁴ S/cm or more and more preferably set to 1×10⁻³ S/cm or more. The upper limit is not particularly limited, but realistically 1×10⁻¹ S/cm or less.

As specific examples of the sulfide-based inorganic solid electrolytes, combination examples of raw materials will be described below. Examples thereof include Li₂S—P₂S₅, Li₂S—P₂S₅—LiCl, Li₂S—P₂S₅—H₂S, Li₂S—P₂S₅—H₂S—LiCl, Li₂S—LiI—P₂S₅, Li₂S—LiI—Li₂O—P₂S₅, Li₂S—LiBr—P₂S₅, Li₂S—Li₂O—P₂S₅, Li₂S—Li₃PO₄—P₂S₅, Li₂S—P₂S₅—P₂O₅, Li₂S—P₂S₅—SiS₂, Li₂S—P₂S₅—SiS₂—LiCl, Li₂S—P₂S₅—SnS, Li₂S—P₂S₅—Al₂S₃, Li₂S—GeS₂, Li₂S—GeS₂—ZnS, Li₂S—Ga₂S₃, Li₂S—GeS₂—Ga₂S₃, Li₂S—GeS₂—P₂S₅, Li₂S—GeS₂—Sb₂S₅, Li₂S—GeS₂—Al₂S₃, Li₂S—SiS₂, Li₂S—Al₂S₃, Li₂S—SiS₂—Al₂S₃, Li₂S—SiS₂—P₂S₅, Li₂S—SiS₂—P₂S₅—LiI, Li₂S—SiS₂—LiI, Li₂S—SiS₂—Li₄SiO₄, Li₂S—SiS₂—Li₃PO₄, Li₁₀GeP₂S₁₂, and the like. Mixing ratios of the respective raw materials do not matter. Examples of a method for synthesizing sulfide-based inorganic solid electrolyte materials using the above-described raw material compositions include an amorphorization method. Examples of the amorphorization method include a mechanical milling method, a solution method, and a melting quenching method. This is because treatments at normal temperature become possible, and it is possible to simplify manufacturing steps.

(ii) Oxide-Based Inorganic Solid Electrolytes Oxide-based inorganic solid electrolytes are preferably compounds which contain oxygen atoms (O), have an ion conductivity of a metal belonging to Group I or II of the periodic table, and have electron-insulating properties.

Specific examples of the compounds include LiₓₐLa_{ya}TiO₃ [xa=0.3 to 0.7 and ya=0.3 to 0.7] (LLT), Li_{xb}La_{yb}Zr_{zb}M^{bb}_{mb}O_{nb} (M^{bb} is at least one element of Al, Mg, Ca, Sr, V, Nb, Ta, Ti, Ge, In or Sn, xb satisfies 5≤xb≤10, yb satisfies 1≤yb≤4, zb satisfies 1≤zb≤4, mb satisfies 0≤mb≤2, and nb satisfies 5≤nb≤20), Li_{xc}B_{yc}M^{cc}_{zc}O_{nc} (M^{cc} is at least one element of C, S, Al, Si, Ga, Ge, In, or Sn, xc satisfies 0≤xc≤5, yc satisfies 0≤yc≤1, zc satisfies 0≤zc≤1, and nc satisfies 0≤nc≤6), Li_{xd}(Al, Ga)_{yd}(Ti, Ge)_{zd}Si_{ad}P_{md}O_{nd} (1≤xd≤3, 0≤yd≤1, 0≤zd≤2, 0≤ad≤1, 1≤md≤7, 3≤nd≤13), Li₍₃₋₂ₓₑ₎M^{ee}ₓₑD^{ee}O (xe represents a number of 0 or more and 0.1 or less, and M^{ee} represents a divalent metal atom. D^{ee} represents a halogen atom or a combination of two or more halogen atoms.), Li_{xf}Si_{yf}O_{zf} (1≤xf≤5, 0≤yf≤3, 1≤zf≤10), Li_{xg}S_{yg}O_{zg} (1≤xg≤3, 0<yg≤2, 1≤zg≤10), Li₃BO₃—Li₂SO₄, Li₂O—B₂O₃—P₂O₅, Li₂O—SiO₂, Li₆BaLa₂Ta₂O₁₂, Li₃PO_{(4-3/2w)}N_{w} (w satisfies w<1), Li_{3.5}Zn_{0.25}GeO₄ having a lithium super ionic conductor (LISICON)-type crystal structure, La_{0.55}Li_{0.35}TiO₃ having a perovskite-type crystal structure, LiTi₂P₃O₁₂ having a natrium super ionic conductor (NASICON)-type crystal structure, Li_{1+xh+yh}(Al, Ga)ₓₕ(Ti, Ge)₂₋ₓₕSi_{yh}P_{3-yh}O₁₂ (0≤xh≤1, 0≤yh≤1), Li₇La₃Zr₂O₁₂ (LLZ) having a garnet-type crystal structure. In addition, phosphorus compounds containing Li, P and O are also desirable. Examples thereof include lithium phosphate (Li₃PO₄), LiPON in which some of oxygen atoms in lithium phosphate are substituted with nitrogen, LiPOD¹ (D¹ is at least one element selected from Ti, V, Cr, Mn, Fe, Co, Ni, Cu, Zr, Nb, Mo, Ru, Ag, Ta, W, Pt, Au, or the like), and the like. It is also possible to preferably use LiA¹ON (A¹ represents at least one element selected from Si, B, Ge, Al, C, Ga, or the like) and the like.

The shape of the inorganic solid electrolyte before being added to the solid electrolyte composition is not particularly limited, but is preferably a particle shape. The volume-average particle diameter of the inorganic solid electrolyte before being added to the solid electrolyte composition is not particularly limited, but is preferably 0.01 μm or more and more preferably 0.1 μm or more. The upper limit is preferably 1,000 μm or less and more preferably 50 μm or less.

Meanwhile, the volume-average particle diameter of the inorganic solid electrolyte particles being added to the solid electrolyte composition can be computed using a method described in the following section of examples.

The shape of the inorganic solid electrolyte in the solid electrolyte composition is not particularly limited, but is preferably a particle shape.

The volume-average particle diameter of the inorganic solid electrolyte in the solid electrolyte composition is not particularly limited, but is preferably small. This is because, in the all-solid state secondary battery, as the volume-average particle diameter of the inorganic solid electrolyte decreases, the surface contact area between the inorganic solid electrolyte and the active material increases, and consequently, it is easier for lithium ions to migrate in the respective layers constituting the all-solid state secondary battery and between the respective layers. The lower limit of the volume-average particle diameter of the inorganic solid electrolyte is practically 0.1 μm or more. On the other hand, in a case in which the surface contact area between the inorganic solid electrolyte and the active material is taken into account, the upper limit of the volume-average particle diameter of the inorganic solid electrolyte is preferably 20 μm or less, more preferably 10 μm or less, and particularly preferably 5 μm or less.

Meanwhile, the volume-average particle diameter of the inorganic solid electrolyte in the solid electrolyte composition can be computed using a method described in the section of examples described below.

In a case in which a decrease in the interface resistance and the maintenance of the decreased interface resistance in the case of being used in the all-solid state secondary battery are taken into account, the content of the inorganic solid electrolyte in the solid component of the solid electrolyte composition is preferably 5% by mass or more, more preferably 10% by mass or more, and particularly preferably 20% by mass or more with respect to 100% by mass of the solid components. From the same viewpoint, the upper limit is preferably 99.9% by mass or less, more preferably 99.5% by mass or less, and particularly preferably 99% by mass or less.

These inorganic solid electrolytes may be used singly or two or more inorganic solid electrolytes may be used in combination.

Meanwhile, the solid content (solid component) in the present specification refers to a component that does not volatilize or evaporate and thus disappear in the case of being subjected to a drying treatment in a nitrogen atmosphere at 170° C. for six hours. Typically, the solid content refers to a component other than a dispersion medium described below.

(Dispersion Media)

The solid electrolyte composition of the embodiment of the invention contains a dispersion medium (B) having a Log P value of 1.2 or less and a dispersion medium (C) having a Log P value of 2 or more, and the mass ratio (C)/(B) of the dispersion medium (C) to the dispersion medium (B) is 100,000≥(C)/(B)≥10.

Meanwhile, the Log P value refers to a value computed using ChemBioDraw (trade name) Version: 12.9.2.1076 manufactured by PerkinElmer Inc.

Since the solid electrolyte composition of the embodiment of the invention is made to contain the dispersion medium (B) and the dispersion medium (C) at the above-described mass ratio, it is possible to disperse the inorganic solid electrolyte miniaturized in the solid electrolyte composition, the dispersion stability of the solid electrolyte composition is improved, and the solid electrolyte-containing sheet is excellent in terms of the ion conductivity. The reason therefor is not clear, but is assumed as described below. That is, it is considered that, in a case in which the solid electrolyte composition includes the dispersion medium (B) having a Log P value of 1.2 or less, it is possible to dissolve and sufficiently miniaturize the inorganic solid electrolyte. Furthermore, it is considered that the inorganic solid electrolyte is stable to the dispersion medium (C) having a Log P value of 2 or more, and thus, in a case in which the solid electrolyte composition includes the dispersion medium (C) at the above-described mass ratio to the dispersion medium (B), it is possible to suppress the excessive dissolution of the inorganic solid electrolyte and restrain a decrease in the ion conductivity to the minimum extent.

In addition, the use of the dispersion media at a specific mass ratio allows the selection of the dispersion media from a relatively large range of Log P values, and thus it is possible to apply a variety of solvents to the preparation of a polymer particle described below.

In the present invention, in order to efficiently satisfy both the miniaturization of the inorganic solid electrolyte and the improvement of the ion conductivity, the mass ratio (C)/(B) is preferably 1,000≥(C)/(B)≥50.

(Dispersion Medium (B))

The Log P value of the dispersion medium (B) is 1.2 or less and more preferably 1.1 or less. In addition, the lower limit is not particularly limited, but is preferably −0.2 or more and more preferably 0.2 or more.

In a case in which the Log P value of the dispersion medium (B) is in the above-described range, it is possible to suppress a decrease in the ion conductivity of the inorganic solid electrolyte and efficiently miniaturize the inorganic solid electrolyte, which is preferable.

The dispersion medium (B) that is used in the present invention is not particularly limited as long as the Log P value is 1.2 or less. Specific examples thereof include an amide compound, a chain-like ether compound, an ester compound, a carbonate compound, a nitrile compound, a ketone compound, an alcohol compound, a halogen-containing compound, a heterocyclic compound, and a sulfonyl compound.

In the present invention, since the balance between the miniaturization of the inorganic solid electrolyte and the ion conductivity is favorable, a ketone compound, a nitrile compound, a halogen-containing compound, a heterocyclic compound in which a hetero atom constituting a ring is a nitrogen atom or a sulfur atom, and a carbonate compound are preferred, a ketone compound, a heterocyclic compound in which a hetero atom constituting a ring is a nitrogen atom or a sulfur atom, and a halogen compound are more preferred, and a heterocyclic compound in which a hetero atom constituting a ring is a nitrogen atom or a sulfur atom is particularly preferred.

The amide compound refers to a compound having a partial structure of Formula (SB-1) and is preferably a compound represented by Formula (SB-11).

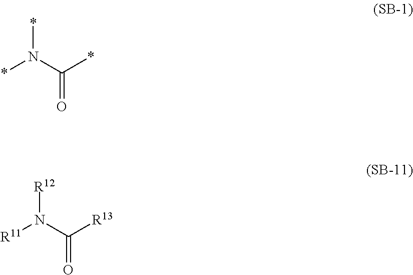

In the formula, R¹¹ represents a hydrogen atom or a substituent. Particularly, a hydrogen atom, an alkyl group (the number of carbon atoms is preferably 1 to 24, more preferably 1 to 12, and particularly preferably 1 to 6), an alkenyl group (the number of carbon atoms is preferably 2 to 12 and more preferably 2 to 6), an aryl group (the number of carbon atoms is preferably 6 to 22 and more preferably 6 to 14), an aralkyl group (the number of carbon atoms is preferably 7 to 23 and more preferably 7 to 15), an alkoxy group (the number of carbon atoms is preferably 1 to 12, more preferably 1 to 6, and particularly preferably 1 to 3), an aryloxy group (the number of carbon atoms is preferably 6 to 22, more preferably 6 to 14, and particularly preferably 6 to 10), an aralkyloxy group (the number of carbon atoms is preferably 7 to 23, more preferably 7 to 15, and particularly preferably 7 to 11), an alkyloxyalkyl group (the total number of carbon atoms of the alkyl is preferably 2 to 24, more preferably 2 to 12, and particularly preferably 2 to 6), a cyano group, a carboxy group, a hydroxy group, a thiol group (sulfanyl group), a sulfonic acid group, a phosphoric acid group, and a phosphonic acid group are preferred. * represents a bonding site in the amide compound.

R¹² and R¹³ are identical to R¹¹, and preferred aspects thereof are also identical thereto. R¹¹ to R¹³ may be identical to or different from one another.

Specific examples of the amide compound include N-methylformamide (NMF) (Log P value: −0.72, boiling point: 183° C.), dimethylformamide (DMF) (Log P value: −0.60, boiling point: 153° C.), N-methylacetamide (Log P value: −0.72, boiling point: 206° C.), N,N-dimethylacetamide (DMAc) (Log P value: −0.49, boiling point: 165° C.), pyrrolidone (Log P value: −0.58, boiling point: 245° C.), N-methylpyrrolidone (NMP) (Log P value: −0.34, boiling point: 202° C.), and N-ethylpyrrolidone (NEP) (Log P value: 0.00, boiling point: 218° C.). Meanwhile, the boiling point in the present specification refers to a boiling point at one atmosphere (1.01×10⁵ Pa).

The chain-like ether compound refers to a compound having a partial structure of Formula (SB-2) and is preferably a compound represented by Formula (SB-21).

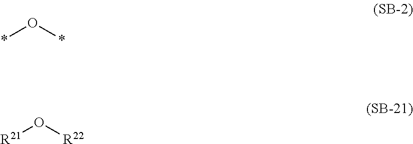

In the formula, R²¹ represents a substituent. The substituent is preferably an alkyl group (the number of carbon atoms is preferably 1 to 24, more preferably 1 to 12, and particularly preferably 1 to 6), an alkenyl group (the number of carbon atoms is preferably 2 to 12 and more preferably 2 to 6), an aryl group (the number of carbon atoms is preferably 6 to 22 and more preferably 6 to 14), an aralkyl group (the number of carbon atoms is preferably 7 to 23 and more preferably 7 to 15), an aryloxy group (the number of carbon atoms is preferably 6 to 22, more preferably 6 to 14, and particularly preferably 6 to 10), an aralkyloxy group (the number of carbon atoms is preferably 7 to 23, more preferably 7 to 15, and particularly preferably 7 to 11), an alkyloxyalkyl group (the total number of carbon atoms of the alkyl is preferably 2 to 24, more preferably 2 to 12, and particularly preferably 2 to 6), or an alkyloxyalkyloxyalkyl group (the total number of carbon atoms of the alkyl is preferably 3 to 24, more preferably 3 to 12, and particularly preferably 3 to 6). Among these, an alkyl group having 1 to 4 carbon atoms, an alkenyl group having 2 to 4 carbon atoms, an 15alkyloxyalkyl group having 2 to 4 carbon atoms in total in an alkyl, and an alkyloxyalkyl group having 2 to 4 carbon atoms in total in an alkyl, and an alkyloxyalkyloxyalkyl group having 3 to 6 carbon atoms in total in an alkyl are particularly preferred. The above-described substituents some of which is substituted into a halogen atom (preferably a fluorine atom, a chlorine atom, a bromine atom, or an iodine atom) are also preferred. * represents a bonding site in the chain-like ether compound.

R²² is identical to R²¹, and a preferred aspect thereof is also identical thereto. R²¹ and R²² may be identical to or different from each other.

Specific examples of the chain-like ether compound include dimethoxyethane (Log P value: −0.07, boiling point: 85° C.), tetraethylene glycol dimethyl ether (tetraglyme) (Log P value: −0.53, boiling point: 276° C.), tetraethylene glycol monomethyl ether (Log P value: −0.90, boiling point: 250° C.), tetraethylene glycol (Log P value: −1.26, boiling point: 328° C.), triethylene glycol (Log P value: −1.10, boiling point: 276° C.), triethylene glycol dimethyl ether (Log P value: −0.38, boiling point: 216° C.), diethylene glycol dimethyl ether (Log P value: −0.22, boiling point: 162° C.), 1,2-dimethoxypropane (Log P value: 0.25, boiling point: 96° C.), and diethyl ether (Log P value: 0.76, boiling point: 35° C.).

The ester compound refers to a compound having a partial structure of Formula (SB-3) and is preferably a compound represented by Formula (SB-31).

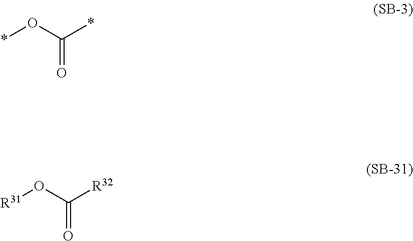

In the formula, a preferred aspect that R³¹ is capable of taking is identical to that of R¹¹. * represents a bonding site in the ester compound. R³² has the same meaning as R³¹, and R³¹ and R³² may be identical to or different from each other.

Specific examples of the ester compound include ethyl acetate (Log P value: 0.29, boiling point: 77° C.), propyl acetate (Log P value: 0.78, boiling point: 101° C.), ethyl propionate (Log P value: −0.95, boiling point: 99° C.), γ-butyrolactone (Log P value: −0.47, boiling point: 204° C.), and γ-valerolactone (Log P value: 0.52, boiling point: 220° C.).

The carbonate compound refers to a compound having a partial structure of Formula (SB-4) and is preferably a compound represented by Formula (SB-41).

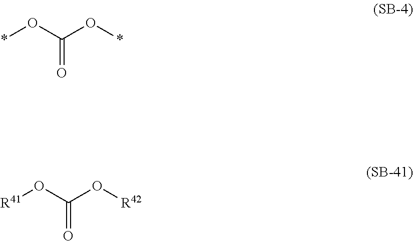

In the formula, R⁴¹ represents a substituent. Particularly, an alkyl group (the number of carbon atoms is preferably 1 to 24, more preferably 1 to 12, and particularly preferably 1 to 6), an alkenyl group (the number of carbon atoms is preferably 2 to 12 and more preferably 2 to 6), an aryl group (the number of carbon atoms is preferably 6 to 22 and more preferably 6 to 14), an aralkyl group (the number of carbon atoms is preferably 7 to 23 and more preferably 7 to 15), an alkoxy group (the number of carbon atoms is preferably 1 to 12, more preferably 1 to 6, and particularly preferably 1 to 3), an aryloxy group (the number of carbon atoms is preferably 6 to 22, more preferably 6 to 14, and particularly preferably 6 to 10), an aralkyloxy group (the number of carbon atoms is preferably 7 to 23, more preferably 7 to 15, and particularly preferably 7 to 11), an alkyloxyalkyl group (the total number of carbon atoms of the alkyl is preferably 2 to 24, more preferably 2 to 12, and particularly preferably 2 to 6), and a hydroxy group are preferred. * represents a bonding site in the carbonate compound.

R⁴² is identical to R⁴¹, and a preferred aspect thereof is also identical thereto. R⁴¹ and R⁴² may be identical to or different from each other.

Specific examples of the carbonate compound include dimethyl carbonate (Log P value: 0.54, boiling point: 90° C.), ethylene carbonate (Log P value: 0.30, boiling point: 261° C.), ethyl methyl carbonate (Log P value: 0.88, boiling point: 107° C.), fluoro ethylene carbonate (Log P value: 0.62, boiling point: 210° C.), and propylene carbonate (Log P value: 0.62, boiling point: 240° C.).

The nitrile compound refers to a compound having a partial structure of Formula (SB-5) and is preferably a compound represented by Formula (SB-51).

*—C≡N (SB-5)

R⁵¹—C≡N (SB-51)

In the formula, R⁵¹ represents a substituent. Particularly, an alkyl group (the number of carbon atoms is preferably 1 to 24, more preferably 1 to 12, and particularly preferably 1 to 6), an alkenyl group (the number of carbon atoms is preferably 2 to 12 and more preferably 2 to 6), an aryl group (the number of carbon atoms is preferably 6 to 22 and more preferably 6 to 14), an aralkyl group (the number of carbon atoms is preferably 7 to 23 and more preferably 7 to 15), an alkyloxy group (the number of carbon atoms is preferably 1 to 24, more preferably 1 to 12, and particularly preferably 1 to 6), an aryloxy group (the number of carbon atoms is preferably 6 to 22, more preferably 6 to 14, and particularly preferably 6 to 10), an aralkyloxy group (the number of carbon atoms is preferably 7 to 23, more preferably 7 to 15, and particularly preferably 7 to 11), and an alkyloxyalkyl group (the total number of carbon atoms of the alkyl is preferably 2 to 24, more preferably 2 to 12, and particularly preferably 2 to 6) are preferred. Among these, an alkyl group having 1 to 4 carbon atoms, an alkenyl group having 2 to 4 carbon atoms, an alkyloxy group having 1 to 4 carbon atoms, and an alkyloxyalkyl group having 2 to 4 carbon atoms in total in an alkyl are particularly preferred. The above-described substituents some of which is substituted into a halogen atom (preferably a fluorine atom, a chlorine atom, a bromine atom, or an iodine atom) are also preferred. * represents a bonding site in the nitrile compound.

Specific examples of the nitrile compound include acetonitrile (Log P value: 0.17, boiling point: 82° C.) and propionitrile (PN) (Log P value: 0.82, boiling point: 97° C.).

The ketone compound refers to a compound having a partial structure of Formula (SB-6) and is preferably a compound represented by Formula (SB-61).

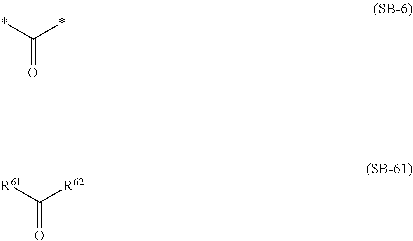

In the formula, a preferred aspect that R⁶¹ is capable of taking is identical to that of R⁴¹. * represents a bonding site in the ketone compound. R⁶² has the same meaning as R⁶¹, and R⁶¹ and R⁶² may be identical to or different from each other.

Specific examples of the ketone compound include acetone (Log P value: 0.20, boiling point: 56° C.) and methyl ethyl ketone (Log P value: 0.86, boiling point: 80° C.).

The alcohol compound refers to a compound having a partial structure of Formula (SB-7) and is preferably a compound represented by Formula (SB-71).

*—OH (SB-7)

R⁷¹—OH (SB-71)

In the formula, a preferred aspect that R⁷¹ is capable of taking is identical to that of R⁵¹. * represents a bonding site in the alcohol compound.

Specific examples of the alcohol compound include methanol (Log P value: −0.27, boiling point: 65° C.), ethanol (Log P value: 0.07, boiling point: 78° C.), 2-propanol (Log P value: 0.38, boiling point: 83° C.), and 1-butanol (Log P value: 0.97, boiling point: 118° C.).

The halogen-containing compound refers to a compound having a partial structure of Formula (SB-8) and is preferably a compound represented by Formula (SB-81).

*—X⁸¹ (SB-8)

R⁸¹—X⁸¹ (SB-81)

In the formulae, a preferred aspect that R⁸¹ is capable of taking is identical to that of R⁵¹. In the formulae, X⁸¹ represents a halogen atom and is preferably a fluorine atom, a chlorine atom, a bromine atom, or an iodine atom and particularly preferably a chlorine atom. * represents a bonding site in the halogen-containing compound.

Specific examples of the halogen-containing compound include dichloromethane (Log P value: 1.01, boiling point: 40° C.).

The heterocyclic compound refers to a compound having a structure of Formula (SB-9).

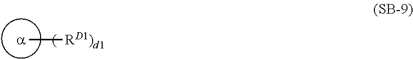

In the formula, a ring α represents a heterocycle, R^{D1} represents a substituent that is bonded with a constituent atom of the ring α, and d1 represents an integer of 1 or more. In a case in which d1 is 2 or more, a plurality of R^{D1}'s may be identical to or different from each other. R^{D1}'s substituted into adjacent atoms may be bonded together to form a ring.

The ring α is preferably a four- to seven-membered ring and more preferably a five- or six-membered ring. An atom constituting the ring α is preferably a carbon atom, an oxygen atom, a nitrogen atom, a sulfur atom, a boron atom, a silicon atom, or a phosphorus atom and particularly preferably a carbon atom, a nitrogen atom, or a sulfur atom. The ring as are coupled together by appropriately forming a single bond, a double bond, or a triple bond and are preferably coupled together by a single bond or a double bond.

R^{D1} represents a hydrogen atom, a halogen atom, or a substituent. The substituent is preferably an alkyl group (the number of carbon atoms is preferably 1 to 24, more preferably 1 to 12, and particularly preferably 1 to 6), an alkenyl group (the number of carbon atoms is preferably 2 to 12 and more preferably 2 to 6), an aryl group (the number of carbon atoms is preferably 6 to 22 and more preferably 6 to 14), an aralkyl group (the number of carbon atoms is preferably 7 to 23 and more preferably 7 to 15), an alkyloxy group (the number of carbon atoms is preferably 1 to 24, more preferably 1 to 12, and particularly preferably 1 to 6), an aryloxy group (the number of carbon atoms is preferably 6 to 22, more preferably 6 to 14, and particularly preferably 6 to 10), an aralkyloxy group (the number of carbon atoms is preferably 7 to 23, more preferably 7 to 15, and particularly preferably 7 to 11), an alkyloxyalkyl group (the total number of carbon atoms of the alkyl is preferably 2 to 24, more preferably 2 to 12, and particularly preferably 2 to 6), a hydroxy group, an amino group, a carboxy group, a phosphonic acid group, or a carbonyl. Among these, a hydrogen atom, an alkyl group having 1 or 2 carbon atoms, an alkenyl group having 2 carbon atoms, an alkyloxy group having 1 or 2 carbon atoms, and an alkyloxyalkyl group having 2 to 4 carbon atoms in total in an alkyl are particularly preferred. The above-described substituents some of which is substituted into a halogen atom (preferably a fluorine atom, a chlorine atom, a bromine atom, or an iodine atom) are also preferred.

Specific examples of the heterocyclic compound include tetrahydrofuran (THF, Log P value: 0.40, boiling point: 66° C.), 1,4-dioxane (Log P value: −0.31, boiling point: 101° C.), pyridine (Log P value: 0.70, boiling point: 115° C.), pyrrole (Log P value: 0.52, boiling point: 129° C.), and pyrrolidine (Log P value: 0.18, boiling point: 87° C.).

The sulfonyl compound refers to a compound having a partial structure of Formula (SB-10) and is preferably a compound represented by Formula (SB-101).

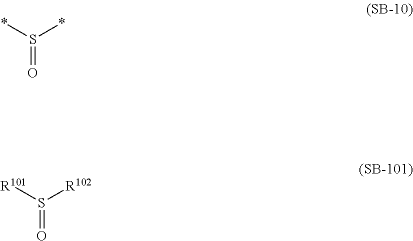

In the formula, a preferred aspect that R¹⁰¹ is capable of taking is identical to that of R⁴¹. * represents a bonding site in the sulfonyl compound. R¹⁰² has the same meaning as R¹⁰¹, and R¹⁰¹ and R¹⁰² may be identical to or different from each other.

Specific examples of the sulfonyl compound include dimethyl sulfoxide (DMSO) (Log P value: −1.49, boiling point: 189° C.).

(Dispersion Medium (C))

The dispersion medium (C) that is used in the present invention is not particularly limited as long as the Log P value is 2 or more. Specific examples thereof include a nitrile compound, a ketone compound, an amine compound, an ether compound, an ester compound, a hydrocarbon compound, and an aromatic compound. In the present invention, a hydrocarbon compound and an aromatic compound are preferred due to their excellent stability with respect to the inorganic solid electrolyte.

The nitrile compound refers to a compound having a partial structure of Formula (SB-5) and is preferably a compound represented by Formula (SB-51). R⁵¹ in the formula is preferably an alkyl group (the number of carbon atoms is preferably 3 to 24, more preferably 3 to 12, and particularly preferably 3 to 6), an alkenyl group (the number of carbon atoms is preferably 3 to 12 and more preferably 3 to 6), an aryl group (the number of carbon atoms is preferably 6 to 22 and more preferably 6 to 14), or an aralkyl group (the number of carbon atoms is preferably 7 to 23 and more preferably 7 to 15). Among these, an alkyl group having 3 to 6 carbon atoms, an alkenyl group having 3 to 6 carbon atoms, and a phenyl group are particularly preferred. The above-described substituents some of which is substituted into a halogen atom (preferably a fluorine atom, a chlorine atom, a bromine atom, or an iodine atom) are also preferred.

Specific examples of the nitrile compound include hexanenitrile (Log P value: 2.08, boiling point: 160° C.).

The ketone compound refers to a compound having a partial structure of Formula (SB-6) and is preferably a compound represented by Formula (SB-61).

In the formula, R⁶¹ represents a hydrogen atom or a substituent. Particularly, an alkyl group (the number of carbon atoms is preferably 3 to 24, more preferably 3 to 12, and particularly preferably 3 to 6), an alkenyl group (the number of carbon atoms is preferably 3 to 12 and more preferably 3 to 6), an aryl group (the number of carbon atoms is preferably 6 to 22 and more preferably 6 to 14), and an aralkyl group (the number of carbon atoms is preferably 7 to 23, more preferably 7 to 15, and particularly preferably 10) are preferred. Meanwhile, in a case in which the substituent is condensed to form a ring, carbon atoms in the substituent may be linked together through a double bond or a triple bond. The ring to be formed is preferably a five-membered ring or a six-membered ring. Among these, R⁶¹ is particularly preferably an alkyl group having 3 or 4 carbon atoms, an alkenyl group having 3 or 4 carbon atoms, or a phenyl group. The substituents that are coupled together to have a ring structure are also preferred. The above-described substituents some of which is substituted into a halogen atom (preferably a fluorine atom, a chlorine atom, a bromine atom, or an iodine atom) are also preferred.

Specific examples of the ketone compound include dibutyl ketone (Log P value: 3.18, boiling point: 186° C.).

The amine compound refers to a compound having a partial structure of Formula (SB-11) and is preferably a compound represented by Formula (SB-111).

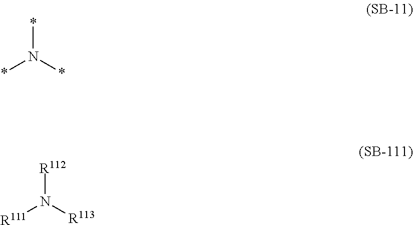

In the formulae, R¹¹¹ represents a substituent. Particularly, an alkyl group (the number of carbon atoms is preferably 3 to 24, more preferably 3 to 12, and particularly preferably 3 to 6), an alkenyl group (the number of carbon atoms is preferably 3 to 12 and more preferably 3 to 6), an aryl group (the number of carbon atoms is preferably 6 to 22 and more preferably 6 to 14), or an aralkyl group (the number of carbon atoms is preferably 7 to 23 and more preferably 7 to 15) are preferred. Among these, an alkyl group having 3 to 6 carbon atoms, an alkenyl group having 3 to 6 carbon atoms, and a phenyl group are particularly preferred. The above-described substituents some of which is substituted into a halogen atom (preferably a fluorine atom, a chlorine atom, a bromine atom, or an iodine atom) are also preferred. Meanwhile, in a case in which the substituent is condensed to form a ring, the carbon atoms in the substituent may be coupled together through a double bond or a triple bond. The ring to be formed is preferably a five-membered ring or six-membered ring. * represents a bonding site in the amine compound. R¹¹² and R¹¹³ have the same meaning as R¹¹¹, and preferred aspects thereof are also identical to one another. R¹¹¹ to R¹¹³ may be identical to or different from one another.

Specific examples of the amine compound include tributylamine (Log P value: 3.97, boiling point: 216° C.) and diisopropylethylamine (Log P value: 3.99, boiling point: 127° C.).

The ether compound refers to a compound having a partial structure of Formula (SB-2) and is preferably a compound represented by Formula (SB-21). In the formula, R²¹ is preferably an alkyl group (the number of carbon atoms is preferably 3 to 24, more preferably 3 to 12, and particularly preferably 3 to 6), an alkenyl group (the number of carbon atoms is preferably 3 to 12 and more preferably 3 to 6), an aryl group (the number of carbon atoms is preferably 6 to 22 and more preferably 6 to 14), or an aralkyl group (the number of carbon atoms is preferably 7 to 23 and more preferably 7 to 15) are preferred. Among these, an alkyl group having 3 to 6 carbon atoms, an alkenyl group having 3 to 6 carbon atoms, and a phenyl group are particularly preferred. The above-described substituents some of which is substituted into a halogen atom (preferably a fluorine atom, a chlorine atom, a bromine atom, or an iodine atom) are also preferred. Meanwhile, in a case in which the substituent is condensed to form a ring, the carbon atoms in the substituent may be coupled together through a double bond or a triple bond. The ring to be formed is preferably a five-membered ring or six-membered ring.

Specific examples of the ether compound include anisole (Log P value: 2.08, boiling point: 154° C.) and dibutyl ether (Log P value: 2.57, boiling point: 142° C.).

Specific examples of the ester compound include butyl butyrate (Log P value: 2.27, boiling point: 165° C.).

The hydrocarbon compound refers to a compound constituted of a carbon atom and a hydrogen atom and may have a chain shape or a cyclic structure. A double bond or a triple bond may be appropriately formed; however, in the case of exhibiting the aromaticity, the hydrocarbon compound does not include any double bonds or triple bonds. The ring to be formed is preferably a five-membered ring or six-membered ring. The number of carbon atoms is preferably 5 to 24, more preferably 6 to 12, and particularly preferably 7 to 9.

Specific examples of the hydrocarbon compound include hexane (Log P value: 3.00, boiling point: 69° C.), heptane (Log P value: 3.42, boiling point: 98° C.), octane (Log P value: 3.84, boiling point: 125° C.), and nonane (Log P value: 4.25, boiling point: 151° C.).

The aromatic compound is preferably a compound represented by Formula (SB-12).

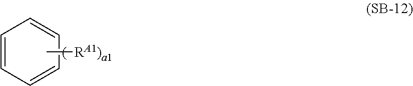

R^{A1} represents a substituent that is bonded with a constituent atom of a benzene ring, and a1 represents an integer of 1 or more. In a case in which a1 is 2 or more, a plurality of R^{A1}'s may be identical to or different from each other. R^{A1}'s substituted into adjacent atoms among the constituent atoms of the benzene ring may be bonded together to form a ring.

R^{A1} represents a hydrogen atom, a halogen atom, or a substituent. The substituent is not particularly limited; however, particularly, an alkyl group (the number of carbon atoms is preferably 1 to 24, more preferably 1 to 6, and particularly preferably 1 to 2), an alkenyl group (the number of carbon atoms is preferably 2 to 12 and more preferably 2), an aryl group (the number of carbon atoms is preferably 6 to 22 and more preferably 6), and an aralkyl group (the number of carbon atoms is preferably 7 to 23 and more preferably 7) are preferred. Among these, a hydrogen atom and an alkyl group having 1 or 2 carbon atoms are particularly preferred. The above-described substituents some of which is substituted into a halogen atom (preferably a fluorine atom, a chlorine atom, a bromine atom, or an iodine atom) are also preferred.

Specific examples of the aromatic compound include toluene (Log P value: 2.52, boiling point: 111° C.), xylene (Log P value: 3.01, boiling point: 140° C.), and methylene (Log P value: 3.50, boiling point: 165° C.).

The dispersion medium (B) and the dispersion medium (C) are preferably mixed together evenly in the case of being mixed together at the above-described mass ratio in order to better dispersibility.

“Being mixed together evenly” means that a plurality of kinds of dispersion media are mixed together uniformly in an environment of normal temperature (25° C.) and normal pressure (760 mmHg) even in a state in which the contents of the dispersion media are 5% by mass or more respectively. “Being mixed together uniformly” means that the mixture remains transparent and the components are not separated from each other even after 24 hours has passed from the mixing. In addition, “being transparent” means that the haze is 10 mg/L or less in the case of being measured using a haze meter (manufactured by Nippon Denshoku Industries Co., Ltd., trade name: HAZE METER NDH4000). Meanwhile, regarding the measurement conditions, the haze was measured under the conditions of JIS K7136 at an optical path length of 10 mm using a D65 light source.

The boiling point of the dispersion medium (B) is not particularly limited, but is preferably 30° C. to 220° C. and more preferably 70° C. to 130° C. In addition, the boiling point of the dispersion medium (C) is not particularly limited, but is preferably 60° C. to 240° C. and more preferably 90° C. to 170° C.

In the production of an all-solid state secondary battery, in order to suppress an excessive increase in the content of the dispersion medium (B) and the consequent reaction with the inorganic solid electrolyte, the boiling point of the dispersion medium (C) is preferably higher than the boiling point of the dispersion medium (B), and the difference between the boiling point of the dispersion medium (C) and the boiling point of the dispersion medium (B) (boiling point of dispersion medium (C)−boiling point of dispersion medium (B)) is preferably 20° C. or higher and more preferably 30° C. or higher. The upper limit is not particularly limited, but is practically 200° C. or lower.

Meanwhile, one kind of each of the dispersion medium (B) and the dispersion medium (C) may be used singly or two or more kinds of each of the dispersion media may be used in combination.

The dispersion media (B) and (C) included in the solid electrolyte composition are preferably removed in a process of producing a solid electrolyte-containing sheet or an all-solid state secondary battery and thus do not remain in the solid electrolyte-containing sheet or the all-solid state secondary battery. The upper limit of the permissible amount of the amount of the dispersion media (B) and/or (C) remaining in the solid electrolyte-containing sheet or the all-solid state secondary battery is preferably 5% by mass or less, more preferably 1% by mass or less, still more preferably 0.1% by mass or less, and particularly preferably 0.05% by mass or less. The lower limit is not particularly specified, but is practically 1 ppb or more (mass-based).

Regarding the expression of compounds in the present specification (for example, in the case of being referred to with “compound” at the end), the scope of the expression includes not only the compound but also salts thereof and ions thereof. In addition, the scope of the expression includes derivatives partially changed by introducing a substituent thereinto as long as a desired effect is exhibited.

Regarding substituents that are not clearly expressed as substituted or unsubstituted in the present specification, the substituents may have an appropriate substituent therein (which shall apply to linking groups). This shall apply to compounds that are not clearly expressed as substituted or unsubstituted.

(Polymer Particle (D))

The solid electrolyte composition of the embodiment of the invention may contain a binder and may preferably contain a polymer particle. The solid electrolyte composition may more preferably contain a polymer particle containing a macromonomer.

The binder that is used in the present invention is not particularly limited as long as the binder is an organic polymer.

Binders that can be used in the present invention are not particularly limited, and, for example, binders made of a resin described below are preferred.

Examples of fluorine-containing resins include polytetrafluoroethylene (PTFE), polyvinylene difluoride (PVdF), and copolymers of polyvinylene difluoride and hexafluoropropylene (PVdF-HFP).

Examples of hydrocarbon-based thermoplastic resins include polyethylene, polypropylene, styrene butadiene rubber (SBR), hydrogenated styrene butadiene rubber (HSBR), butylene rubber, acrylonitrile butadiene rubber, polybutadiene, polyisoprene, polyisoprene latex, and the like.

Examples of acrylic resins include a variety of (meth)acrylic monomers, (meth)acrylic amide monomers, and copolymers of monomers constituting these resins (preferably copolymers of acrylic acid and methyl acrylate).

In addition, copolymers with other vinyl-based monomers are also preferably used. Examples thereof include copolymers of methyl (meth)acrylate and styrene, copolymers of methyl (meth)acrylate and acrylonitrile, and copolymers of butyl (meth)acrylate, acrylonitrile, and styrene. In the specification of the present application, a copolymer may be any one of a statistic copolymer, a periodic copolymer, a blocked copolymer, and a graft copolymer, and a blocked copolymer is preferred.

Examples of other resins include a polyurethane resin, a polyurea resin, a polyamide resin, a polyimide resin, a polyester resin, a polyether resin, a polycarbonate resin, a cellulose derivative resin, and the like.

Among these, fluorine-containing resins, hydrocarbon-based thermoplastic resins, acrylic resins, polyurethane resins, polycarbonate resins, and cellulose derivative resins are preferred, and acrylic resins and polyurethane resins are particularly preferred.

These binders may be used singly or two or more binders may be used in combination.

The shape of the binder is not particularly limited and may be a particle shape or an irregular shape in the all-solid state secondary battery and is preferably a particle shape.

The binder may be made of one kind of compound or a combination of two or more kinds of compounds. In a case in which the binder is particles, the particles may have a core-shell shape or a hollow shape instead of a homogeneous dispersion. In addition, an organic substance or an inorganic substance may be included in a core portion that forms the inside of the binder. Examples of the organic substance included in the core portion include the dispersion media, the dispersant, the lithium salt, the ionic liquid, the conductive auxiliary agent, and the like.

Meanwhile, as the binder that is used in the present invention, a commercially available product can be used. In addition, the binder can also be prepared using an ordinary method.

The moisture concentration of the binder that is used in the present invention is preferably 100 ppm (mass-based) or less.

In addition, the binder that is used in the present invention may be used in a solid state or may be used in a state of a polymer particle dispersionic liquid or a polymer solution.

The mass-average molecular weight of the binder that is used in the present invention is preferably 5,000 or more, more preferably 10,000 or more, and still more preferably 30,000 or more. The upper limit is practically 1,000,000 or less, but an aspect in which a binder having a mass-average molecular weight in the above-described range is crosslinked is also preferred.

—Measurement of Molecular Weight—

Unless particularly otherwise described, the molecular weight of the binder in the present invention refers to the mass-average molecular weight, and the standard polystyrene-equivalent mass-average molecular weight is measured by means of gel permeation chromatography (GPC). Regarding the measurement method, basically, a value measured using a method under the following condition 1 or condition 2 (preferential) is used. Here, an appropriate eluent may be appropriately selected and used depending on the kind of the binder.

(Condition 1)

Column: Two TOSOH TSKgel Super AWM-H (trade name) are connected together

Carrier: 10 mM LiBr/N-methylpyrrolidone

Measurement temperature: 40° C.

Carrier flow rate: 1.0 mL/min

Specimen concentration: 0.1% by mass

Detector: Refractive index (RI) detector

(Condition 2) Preferential

Column: A column obtained by connecting TOSOH TSKgel Super HZM-H (trade name), TOSOH TSKgel Super HZ4000 (trade name), and TOSOH TSKgel Super HZ 2000 (trade name) is used

Carrier: Tetrahydrofuran

Measurement temperature: 40° C.

Carrier flow rate: 1.0 mL/min

Specimen concentration: 0.1% by mass

Detector: Refractive index (RI) detector

In a case in which a decrease in the interface resistance and the maintenance of the decreased interface resistance when used in an all-solid state secondary battery are taken into account, the content of the binder in the solid electrolyte composition is preferably 0.01% by mass or more, more preferably 0.1% by mass or more, and still more preferably 1% by mass or more in 100% by mass of the solid components. From the viewpoint of the battery characteristics, the upper limit is preferably 10% by mass or less, more preferably 5% by mass or less, and still more preferably 3% by mass or less.

In the present invention, the mass ratio [(the mass of the inorganic solid electrolyte and the mass of the active material)/the mass of the binder] of the total mass (total amount) of the inorganic solid electrolyte and the active material to the mass of the binder is preferably in a range of 1,000 to 1. Furthermore, this ratio is more preferably 500 to 2 and more preferably 100 to 10.

In the present invention, the binder is preferably a polymer particle (D) that is insoluble in the dispersion medium (B) and the dispersion medium (C) from the viewpoint of the dispersion stability of the solid electrolyte composition. Here, “the polymer particle (D) is a particle that is insoluble in the dispersion medium (B) and the dispersion medium (C)” means that, even in a case in which the polymer particles are added to a dispersion medium (30° C.) and left to stand for 24 hours, the average particle diameter thereof is 5 nm or more, preferably 10 nm or more, and more preferably 30 nm or more.

(Active Material (E))

The solid electrolyte composition of the embodiment of the invention may also contain an active material (E) capable of inserting and discharging an ion of a metal element belonging to Group I or II of the periodic table. Hereinafter, the active material (E) will also be simply referred to as the active material.

As the active material, a positive electrode active material and a negative electrode active material are exemplified, and a metal oxide (preferably a transition metal oxide) that is a positive electrode active material, a metal oxide that is a negative electrode active material, and metals capable of forming an alloy with lithium such as Sn, Si, Al, and In are preferred.

In the present invention, the solid electrolyte composition containing the active material (a positive electrode active material or a negative electrode active material) will be referred to as the composition for an electrode (the composition for a positive electrode or the composition for a negative electrode) in some cases.

—Positive Electrode Active Material—

A positive electrode active material that the solid electrolyte composition of the embodiment of the invention may contain is preferably a positive electrode active material capable of reversibly intercalating and deintercalating lithium ions. The above-described material is not particularly limited as long as the material has the above-described characteristics and may be transition metal oxides, organic substances, elements capable of being complexed with Li such as sulfur, complexes of sulfur and metal, or the like.

Among these, as the positive electrode active material, transition metal oxides are preferably used, and transition metal oxides having a transition metal element M^{a} (one or more elements selected from Co, Ni, Fe, Mn, Cu, and V) are more preferred. In addition, an element M^{b} (an element of Group I (Ia) of the metal periodic table other than lithium, an element of Group II (IIa), or an element such as Al, Ga, In, Ge, Sn, Pb, Sb, Bi, Si, P, or B) may be mixed into this transition metal oxide. The amount of the element mixed is preferably 0 to 30 mol % of the amount (100 mol %) of the transition metal element M^{a}. The positive electrode active material is more preferably synthesized by mixing the element into the transition metal oxide so that the molar ratio of Li/M^{a} reaches 0.3 to 2.2.

Specific examples of the transition metal oxides include transition metal oxides having a bedded salt-type structure (MA), transition metal oxides having a spinel-type structure (MB), lithium-containing transition metal phosphoric acid compounds (MC), lithium-containing transition metal halogenated phosphoric acid compounds (MD), lithium-containing transition metal silicate compounds (ME), and the like.

Specific examples of the transition metal oxides having a bedded salt-type structure (MA) include LiCoO₂ (lithium cobalt oxide [LCO]), LiNi₂O₂ (lithium nickelate), LiNi_{0.85}Co_{0.10}Al_{0.05}O₂ (lithium nickel cobalt aluminum oxide [NCA]), LiNi_{1/3}Co_{1/3}Mn_{1/3}O₂ (lithium nickel manganese cobalt oxide [NMC]), and LiNi_{0.5}Mn_{0.5}O₂ (lithium manganese nickelate).

Specific examples of the transition metal oxides having a spinel-type structure (MB) include LiMn₂O₄(LMO), LiCoMnO₄, Li₂FeMn₃O₈, Li₂CuMn₃O₈, Li₂CrMn₃O₈, and Li₂NiMn₃O₈.

Examples of the lithium-containing transition metal phosphoric acid compounds (MC) include olivine-type iron phosphate salts such as LiFePO₄ and Li₃Fe₂(PO₄)₃, iron pyrophosphates such as LiFeP₂O₇, and cobalt phosphates such as LiCoPO₄, and monoclinic nasicon-type vanadium phosphate salt such as Li₃V₂(PO₄)₃ (lithium vanadium phosphate).

Examples of the lithium-containing transition metal halogenated phosphoric acid compounds (MD) include iron fluorophosphates such as Li₂FePO₄F, manganese fluorophosphates such as Li₂MnPO₄F, cobalt fluorophosphates such as Li₂CoPO₄F.

Examples of the lithium-containing transition metal silicate compounds (ME) include Li₂FeSiO₄, Li₂MnSiO₄, Li₂CoSiO₄, and the like.

In the present invention, the transition metal oxides having a bedded salt-type structure (MA) is preferred, and LCO or NMC is more preferred.

The shape of the positive electrode active material is not particularly limited, but is preferably a particle shape. The volume-average particle diameter (circle-equivalent average particle diameter) of positive electrode active material particles is not particularly limited. For example, the volume-average particle diameter can be set to 0.1 to 50 μm. In order to provide a predetermined particle diameter to the positive electrode active material, an ordinary crusher or classifier may be used. Positive electrode active materials obtained using a firing method may be used after being washed with water, an acidic aqueous solution, an alkaline aqueous solution, or an organic solvent. The volume-average particle diameter (circle-equivalent average particle diameter) of positive electrode active material particles can be measured using a laser diffraction/scattering-type particle size distribution measurement instrument LA-920 (trade name, manufactured by Horiba Ltd.).

The positive electrode active material may be used singly or two or more positive electrode active materials may be used in combination.

In the case of forming a positive electrode active material layer, the mass (mg) of the positive electrode active material per unit area (cm²) of the positive electrode active material layer (weight per unit area) is not particularly limited and can be appropriately determined depending on the set battery capacity.

The content of the positive electrode active material in the solid electrolyte composition is not particularly limited, but is preferably 10% to 95% by mass, more preferably 30% to 90% by mass, still more preferably 50% to 85% by mass, and particularly preferably 55% to 80% by mass with respect to a solid content of 100% by mass.

—Negative Electrode Active Material—

A negative electrode active material that the solid electrolyte composition of the embodiment of the invention may contain is preferably a negative electrode active material capable of reversibly intercalating and deintercalating lithium ions. The above-described material is not particularly limited as long as the material has the above-described characteristics, and examples thereof include carbonaceous materials, metal oxides such as tin oxide, silicon oxide, metal complex oxides, a lithium single body, lithium alloys such as lithium aluminum alloys, metals capable of forming alloys with lithium such as Sn, Si, Al, and In and the like. Among these, carbonaceous materials or metal complex oxides are preferably used in terms of reliability. In addition, the metal complex oxides are preferably capable of absorbing and deintercalating lithium. The materials are not particularly limited, but preferably contain titanium and/or lithium as constituent components from the viewpoint of high-current density charging and discharging characteristics.

The carbonaceous material that is used as the negative electrode active material is a material substantially consisting of carbon. Examples thereof include petroleum pitch, carbon black such as acetylene black (AB), graphite (natural graphite, artificial graphite such as highly oriented pyrolytic graphite), and carbonaceous material obtained by firing α variety of synthetic resins such as polyacrylonitrile (PAN)-based resins or furfuryl alcohol resins. Furthermore, examples thereof also include a variety of carbon fibers such as PAN-based carbon fibers, cellulose-based carbon fibers, pitch-based carbon fibers, vapor-grown carbon fibers, dehydrated polyvinyl alcohol (PVA)-based carbon fibers, lignin carbon fibers, glassy carbon fibers, and active carbon fibers, mesophase microspheres, graphite whisker, flat graphite, and the like.

The metal oxides and the metal complex oxides being applied as the negative electrode active material are particularly preferably amorphous oxides, and furthermore, chalcogenides which are reaction products between a metal element and an element belonging to Group XVI of the periodic table are also preferably used. The amorphous oxides mentioned herein refer to oxides having a broad scattering band having a peak of a 20 value in a range of 20° to 40° in an X-ray diffraction method in which CuKα rays are used and may have crystalline diffraction lines.

In a compound group consisting of the amorphous oxides and the chalcogenides, amorphous oxides of semimetal elements and chalcogenides are more preferred, and elements belonging to Groups XIII (IIIB) to XV (VB) of the periodic table, oxides consisting of one element or a combination of two or more elements of Al, Ga, Si, Sn, Ge, Pb, Sb, and Bi, and chalcogenides are particularly preferred. Specific examples of preferred amorphous oxides and chalcogenides include Ga₂O₃, SiO, GeO, SnO, SnO₂, PbO, PbO₂, Pb₂O₃, Pb₂O₄, Pb₃O₄, Sb₂O₃, Sb₂O₄, Sb₂O₈Bi₂O₃, Sb₂O₈Si₂O₃, Bi₂O₄, SnSiO₃, GeS, SnS, SnS₂, PbS, PbS₂, Sb₂S₃, Sb₂S₅, and SnSiS₃. In addition, these amorphous oxides may be complex oxides with lithium oxide, for example, Li₂SnO₂.

The negative electrode active material preferably contains a titanium atom. More specifically, Li₄Ti₅O₁₂ (lithium titanium oxide [LTO]) is preferred since the volume fluctuation during the absorption and deintercalation of lithium ions is small, and thus the high-speed charging and discharging characteristics are excellent, and the deterioration of electrodes is suppressed, whereby it becomes possible to improve the service lives of lithium ion secondary batteries.

In the present invention, a Si-based negative electrode is also preferably applied. Generally, a Si negative electrode is capable of absorbing a larger number of Li ions than a carbon negative electrode (graphite, acetylene black, or the like). That is, the amount of Li ions absorbed per unit mass increases. Therefore, it is possible to increase the battery capacity. As a result, there is an advantage that the battery drying duration can be extended.

The shape of the negative electrode active material is not particularly limited, but is preferably a particle shape. The average particle diameter of the negative electrode active material is preferably 0.1 μm to 60 μm. In order to provide a predetermined particle diameter, an ordinary crusher or classifier is used. For example, a mortar, a ball mill, a sand mill, an oscillatory ball mill, a satellite ball mill, a planetary ball mill, a swirling airflow-type jet mill, a sieve, or the like is preferably used. During crushing, it is also possible to carry out wet-type crushing in which water or an organic solvent such as methanol is made to coexist as necessary. In order to provide a desired particle diameter, classification is preferably carried out. The classification method is not particularly limited, and it is possible to use a sieve, a wind power classifier, or the like depending on the necessity. Both of dry-type classification and wet-type classification can be carried out. The average particle diameter of negative electrode active material particles can be measured using the same method as the method for measuring the volume-average particle diameter of the positive electrode active material.

The chemical formulae of the compounds obtained using a firing method can be computed using an inductively coupled plasma (ICP) emission spectroscopic analysis method as a measurement method from the mass difference of powder before and after firing as a convenient method.

The negative electrode active material may be used singly or two or more negative electrode active materials may be used in combination.

In the case of forming a negative electrode active material layer, the mass (mg) of the negative electrode active material per unit area (cm²) in the negative electrode active material layer (weight per unit area) is not particularly limited and can be appropriately determined depending on the set battery capacity.

The content of the negative electrode active material in the solid electrolyte composition is not particularly limited, but is preferably 10% to 80% by mass and more preferably 20% to 80% by mass with respect to a solid content of 100% by mass.

The surfaces of the positive electrode active material and/or the negative electrode active material may be coated with a separate metal oxide. Examples of the surface coating agent include metal oxides and the like containing Ti, Nb, Ta, W, Zr, Al, Si, or Li. Specific examples thereof include titanium oxide spinel, tantalum-based oxides, niobium-based oxides, lithium niobite-based compounds, and the like, and specific examples thereof include Li₄Ti₅O₁₂, Li₂Ti₂O₅, LiTaO₃, LiNbO₃, LiAlO₂, Li₂ZrO₃, Li₂WO₄, Li₂TiO₃, Li₂B₄O₇, Li₃PO₄, Li₂MoO₄, Li₃BO₃, LiBO₂, Li₂CO₃, Li₂SiO₃, SiO₂, TiO₂, ZrO₂, Al₂O₃, B₂O₃, and the like.

In addition, a surface treatment may be carried out on the surfaces of electrodes including the positive electrode active material or the negative electrode active material using sulfur, phosphorous, or the like.

Furthermore, the particle surfaces of the positive electrode active material or the negative electrode active material may be treated with an active light ray or an active gas (plasma or the like) before or after the coating of the surfaces.

(Dispersant)

The solid electrolyte composition of the embodiment of the invention may also contain a dispersant. The addition of the dispersant enables the suppression of the agglomeration of the electrode active material and the inorganic solid electrolyte even in a case in which the content of any of the electrode active material and the inorganic solid electrolyte is great or a case in which the particle diameters are small and the surface area increases and the formation of a uniform active material layer and a uniform solid electrolyte layer. As the dispersant, a dispersant that is generally used for an all-solid state secondary battery can be appropriately selected and used. Generally, a compound intended for particle adsorption and steric repulsion and/or electrostatic repulsion is preferably used.

(Lithium Salt)

The solid electrolyte composition of the embodiment of the invention may also contain a lithium salt (Li salt).

A lithium salt that can be used in the present invention is preferably a lithium salt that is ordinarily used in this kind of product and is not particularly limited, and, for example, lithium salts described below are preferred.

(L-1) Inorganic lithium salts: inorganic fluoride salts such as LiPF₆, LiBF₄, LiAsF₆, and LiSbF₆; perhalogen acid salts such as LiClO₄, LiBrO₄, and LiIO₄; inorganic chloride salts such as LiAlCl₄⁻; and the like.

(L-2) Fluorine-containing organic lithium salts: perfluoroalkanesulfonate salts such as LiCF₃SO₃; perfluoroalkanesulfonylimide salts such as LiN(CF₃SO₂)₂ (LiTFSI), LiN(CF₃CF₂SO₂)₂, LiN(FSO₂)₂, and LiN(CF₃SO₂) (C₄F₉SO₂); perfluoroalkanesulfonylmethide salts such as LiC(CF₃SO₂)₃; fluoroalkylfluoride phosphate salts such as Li[PF₅(CF₂CF₂CF₃)], Li[PF₄(CF₂CF₂CF₃)₂], Li[PF₃(CF₂CF₂CF₃)₃], Li[PF₅(CF₂CF₂CF₂CF₃)], Li[PF₄(CF₂CF₂CF₂CF₃)₂], Li[PF₃(CF₂CF₂CF₂CF₃)₃]; and the like.

(L-3) Oxalatoborate salts: lithium bis(oxalato)borate, lithium difluorooxalatoborate, and the like.

Among these, LiPF₆, LiBF₄, LiAsF₆, LiSbF₆, LiClO₄, Li(Rf¹SO₃), LiN(Rf¹SO₂)₂, LiN(FSO₂)₂, and LiN(Rf¹SO₂) (Rf²SO₂) are preferred, and lithium imide salts such as LiPF₆, LiBF₄, LiN(Rf¹SO₂), LiN(FSO₂)₂, and LiN(Rf¹SO₂) (Rf²SO₂) are more preferred. Here, Rf¹ and Rf² respectively represent perfluoroalkyl groups.

Meanwhile, the lithium salt may be used singly or two or more lithium salts may be used in random combination.

The content of the lithium salt is preferably 0.1 parts by mass or more and more preferably 0.5 parts by mass or more with respect to 100 parts by mass of the inorganic solid electrolyte. The upper limit is preferably 10 parts by mass or less and more preferably 5 parts by mass or less.

(Ionic Liquid)

The solid electrolyte composition of the embodiment of the invention may also contain an ionic liquid in order to further improve the ion conductivity of the solid electrolyte-containing sheet or individual layers constituting the all-solid state secondary battery. The ionic liquid is not particularly limited, but an ionic liquid dissolving the above-described lithium salt is preferred from the viewpoint of effectively improving the ion conductivity. Examples thereof include compounds made of a combination of a cation and an anion described below.

(i) Cation

Examples of the cation include an imidazolium cation, a pyridinium cation, a piperidinium cation, a pyrrolidinium cation, a morpholinium cation, a phosphonium cation, a quaternary ammonium cation, and the like. Here, these cations have the following substituent.

As the cation, these cations may be used singly or two or more cations may be used in combination.

A quaternary ammonium cation, a piperidinium cation, or a pyrrolidinium cation is preferred.

Examples of the substituent that the above-described cations have include an alkyl group (preferably an alkyl group having 1 to 8 carbon atoms and more preferably an alkyl group having 1 to 4 carbon atoms), a hydroxyalkyl group (preferably a hydroxyalkyl group having 1 to 3 carbon atoms), an alkyloxyalkyl group (preferably an alkyloxyalkyl group having 2 to 8 carbon atoms and more preferably an alkyloxyalkyl group having 2 to 4 carbon atoms), an ether group, an allyl group, an aminoalkyl group (preferably an aminoalkyl group having 1 to 8 carbon atoms and preferably an aminoalkyl group having 1 to 4 carbon atoms), and an aryl group (preferably an aryl group having 6 to 12 carbon atoms and more preferably an aryl group having 6 to 8 carbon atoms). The substituent may form a cyclic structure in a form of containing a cation site. The substituents may further have the substituent described in the section of the dispersion medium. Meanwhile, the ether group is used in combination with a different substituent. Examples of the different substituent include an alkyloxy group, an aryloxy group, and the like.

(ii) Anion

Examples of the anion include a chloride ion, a bromide ion, an iodide ion, a boron tetrafluoride ion, a nitric acid ion, a dicyanamide ion, an acetate ion, an iron tetrachloride ion, a bis(trifluoromethanesulfonyl)imide ion, a bis(fluorosulfonyl)imide ion, a bis(perfluorobutylmethanesulfonyl)imide ion, an allylsulfonate ion, a hexafluorophosphate ion, a trifluoromethanesulfonate ion, and the like.

As the anion, these anions may be used singly or two or more anions may also be used in combination.

A boron tetrafluoride ion, a bis(trifluoromethanesulfonyl)imide ion, a bis(fluorosulfonyl)imide ion, a hexafluorophosphate ion, a dicyanamide ion, and an allylsulfonate ion are preferred, and a bis(trifluoromethanesulfonyl)imide ion, a bis(fluorosulfonyl)imide ion, and an allylsulfonate ion are more preferred.

Examples of the ionic liquid include 1-allyl-3-ethylimidazolium bromide, 1-ethyl-3-methylimidazolium bromide, 1-(2-hydroxyethyl)-3-methylimidazolium bromide, 1-(2-methoxyethyl)-3-methylimidazolium bromide, 1-octyl-3-methylimidazolium chloride, N,N-diethyl-N-methyl-N-(2-methoxyethyl)ammonium tetrafluoroborate, 1-ethyl-3-methylimidazolium bis(trifluoromethanesulfonyl)imide, 1-ethyl-3-methylimidazolium bis(fluorosulfonyl)imide, 1-ethyl-3-methylimidazolium dicyanamide, 1-butyl-1-methylpyrrolidinium bis(trifluoromethanesulfonyl)imide, trimethylbutylammonium bis(trifluoromethanesulfonyl)imide, N,N-diethyl-N-methyl-N-(2-methoxyethyl) ammonium bis(trifluoromethanesulfonyl)imide (DEME), N-propyl-N-methylpyrrolidium bis(trifluoromethanesulfonyl)imide (PMP), N-(2-methoxyethyl)-N-methylpyrrolidinium tetrafluoroboride, 1-butyl-1-methylpyrrolidinium bis(fluorosulfonyl)imide, (2-acryloylethyl) trimethylammonium bis(trifluoromethanesulfonyl)imide, 1-ethyl-1-methylpyrrolidinium allyl sulfonate, 1-ethyl-3-methylimidazolium allylsulfonate, and trihexyltetradecylphosphonium chloride.

The content of the ionic liquid is preferably 0 parts by mass or more, more preferably 1 part by mass or more, and most preferably 2 part by mass or more with respect to 100 parts by mass of the inorganic solid electrolyte. The upper limit is preferably 50 parts by mass or less, more preferably 20 parts by mass or less, and particularly preferably 10 parts by mass or less.

The mass ratio between the lithium salt and the ionic liquid (lithium salt:ionic liquid) is preferably 1:20 to 20:1, more preferably 1:10 to 10:1, and most preferably 1:7 to 2:1.

(Conductive Auxiliary Agent)

The solid electrolyte composition of the embodiment of the invention may also contain a conductive auxiliary agent. The conductive auxiliary agent is not particularly limited, and conductive auxiliary agents that are known as ordinary conductive auxiliary agents can be used. The conductive auxiliary agent may be, for example, graphite such as natural graphite or artificial graphite, carbon black such as acetylene black, Ketjen black, or furnace black, irregular carbon such as needle cokes, a carbon fiber such as a vapor-grown carbon fiber or a carbon nanotube, or a carbonaceous material such as graphene or fullerene which are electron-conductive materials and also may be metal powder or a metal fiber of copper, nickel, or the like, and a conductive polymer such as polyaniline, polypyrrole, polythiophene, polyacetylene, or a polyphenylene derivative may also be used. In addition, these conductive auxiliary agents may be used singly or two or more conductive auxiliary agents may be used.

(Preparation of Solid Electrolyte Composition)

The solid electrolyte composition of the embodiment of the invention can be prepared by dispersing the inorganic solid electrolyte (A) in the presence of the dispersion medium (B) and the dispersion medium (C) to produce a slurry.

The slurry can be produced by mixing the inorganic solid electrolyte, the dispersion medium (B), and the dispersion medium (C) using a variety of mixers. The mixing device is not particularly limited, and examples thereof include a ball mill, a beads mill, a planetary mixer, a blade mixer, a roll mill, a kneader, and a disc mill. The mixing conditions are not particularly limited; however, in the case of using a ball mill, the inorganic solid electrolyte and the dispersion medium are preferably mixed together at 150 to 700 rpm (rotation per minute) for one hour to 24 hours.

In the case of preparing α solid electrolyte composition containing components such as a binder, an active material and a particle dispersant, the components may be added and mixed at the same time as a dispersion step of the inorganic solid electrolyte (A) or may be separately added and mixed.

[Sheet for all-Solid State Secondary Battery]

The solid electrolyte-containing sheet of the embodiment of the invention can be preferably used in all-solid state secondary batteries and is modified in a variety of aspects depending on the uses. Examples thereof include a sheet that is preferably used in a solid electrolyte layer (also referred to as a solid electrolyte sheet for an all-solid state secondary battery), a sheet that is preferably used in an electrode or a laminate of an electrode and a solid electrolyte layer (an electrode sheet for an all-solid state secondary battery), and the like. In the present invention, a variety of sheets described above will be collectively referred to as a sheet for an all-solid state secondary battery in some cases.

The sheet for an all-solid state secondary battery is a sheet having a solid electrolyte layer or an active material layer (electrode layer) on a base material. This sheet for an all-solid state secondary battery may further have other layers as long as the sheet has the base material and the solid electrolyte layer or the active material layer, but a sheet containing an active material is classified into an electrode sheet for an all-solid state secondary battery described below. Examples of other layers include a protective layer, a collector, a coating layer (a collector, a solid electrolyte layer, or an active material layer), and the like.

Examples of the solid electrolyte sheet for an all-solid state secondary battery include a sheet having a solid electrolyte layer and a protective layer on a base material in this order.

The base material is not particularly limited as long as the base material is capable of supporting the solid electrolyte layer, and examples thereof include sheet bodies (plate-like bodies) of materials, organic materials, inorganic materials, and the like described in the section of the collector described below. Examples of the organic materials include a variety of polymers and the like, and specific examples thereof include polyethylene terephthalate, polypropylene, polyethylene, cellulose, and the like. Examples of the inorganic materials include glass, ceramic, and the like.

The layer thickness of the solid electrolyte layer in the sheet for an all-solid state secondary battery is identical to the layer thickness of the solid electrolyte layer described in the section of an all-solid state secondary battery of the embodiment of the invention.

This sheet is obtained by forming a film of the solid electrolyte composition of the embodiment of the invention (by means of application and drying) on the base material (possibly, through other layers) and forming a solid electrolyte layer on the base material.

Here, the solid electrolyte composition of the embodiment of the invention can be prepared using the above-described method.

An electrode sheet for an all-solid state secondary battery of the embodiment of the invention (also simply referred to as “the electrode sheet”) is an electrode sheet having an active material layer on a metal foil as a collector for forming an active material layer in an all-solid state secondary battery of the embodiment of the invention. This electrode sheet is generally a sheet having a collector and an active material layer, and an aspect of having a collector, an active material layer, and a solid electrolyte layer in this order and an aspect of having a collector, an active material layer, a solid electrolyte layer, and an active material layer in this order are also considered as the electrode sheet.

The layer thicknesses of the respective layers constituting the electrode sheet are identical to the layer thicknesses of individual layers described in the section of an all-solid state secondary battery of the embodiment of the invention.

The electrode sheet is obtained by forming a film of the solid electrolyte composition of the embodiment of the invention which contains the active material (by means of application and drying) on the metal foil and forming an active material layer on the metal foil. A method for preparing the solid electrolyte composition containing an active material is identical to the method for preparing the solid electrolyte composition except for the fact that the active material is used.

[All-Solid State Secondary Battery]

An all-solid state secondary battery of the embodiment of the invention has a positive electrode, a negative electrode facing the positive electrode, and a solid electrolyte layer between the positive electrode and the negative electrode. The positive electrode has a positive electrode active material layer on a positive electrode collector. The negative electrode has a negative electrode active material layer on a negative electrode collector.

At least one layer of the negative electrode active material layer, the positive electrode active material layer, or the solid electrolyte layer is preferably formed using the solid electrolyte composition of the embodiment of the invention.

The kinds and the content ratio of the components of the active material layers and/or the solid electrolyte layer formed of the solid electrolyte composition are preferably identical to those in the solid content of the solid electrolyte composition.

Hereinafter, a preferred embodiment of the present invention in which a polymer particle is used will be described with reference to FIG. 1, but the present invention is not limited thereto.

[Positive Electrode Active Material Layer, Solid Electrolyte Layer, and Negative Electrode Active Material Layer]

In the all-solid state secondary battery 10, at least one of the positive electrode active material layer, the solid electrolyte layer, or the negative electrode active material layer is formed using the solid electrolyte composition of the embodiment of the invention.

That is, the solid electrolyte layer 3 is formed of the solid electrolyte composition of the embodiment of the invention which includes a polymer particle, the solid electrolyte layer 3 includes the inorganic solid electrolyte and the polymer particle. The solid electrolyte layer, generally, does not include any positive electrode active material and/or any negative electrode active material. In the solid electrolyte layer 3, it is considered that the polymer particle is present between the solid particles of the active materials and the like in the inorganic solid electrolyte and the adjacent active material layers. Therefore, the interface resistance between solid particles is reduced, and the binding property is enhanced.

In a case in which the positive electrode active material layer 4 and/or the negative electrode active material layer 2 are formed using the solid electrolyte composition of the embodiment of the invention which includes a polymer particle, the positive electrode active material layer 4 and the negative electrode active material layer 2 respectively include a positive electrode active material or a negative electrode active material and further include the inorganic solid electrolyte and the polymer particle. In a case in which the active material layers contain the inorganic solid electrolyte, it is possible to improve the ion conductivity. In the active material layers, it is considered that the polymer particle is present between solid particles. Therefore, the interface resistance between solid particles is reduced, and the binding property is enhanced.

The kinds of the inorganic solid electrolytes and the polymer particle that the positive electrode active material layer 4, the solid electrolyte layer 3, and the negative electrode active material layer 2 contain may be identical to or different from each other.

In the present invention, any layer of the negative electrode active material layer, the positive electrode active material layer, and the solid electrolyte layer in the all-solid state secondary battery is produced using the solid electrolyte composition containing the polymer particle and the solid particles such as the inorganic solid electrolyte. Therefore, it is possible to improve the binding property between solid particles, and consequently, favorable cycle characteristics of the all-solid state secondary battery can also be realized.

[Collector (Metal Foil)]

The positive electrode collector 5 and the negative electrode collector 1 are preferably an electron conductor.

In the present invention, there are cases in which any or both of the positive electrode collector and the negative electrode collector will be simply referred to as the collector.

As a material forming the positive electrode collector, aluminum, an aluminum alloy, stainless steel, nickel, titanium, or the like, and furthermore, a material obtained by treating the surface of aluminum or stainless steel with carbon, nickel, titanium, or silver (a material forming a thin film) is preferred, and, among these, aluminum and an aluminum alloy are more preferred.

As a material forming the negative electrode collector, aluminum, copper, a copper alloy, stainless steel, nickel, titanium, or the like, and furthermore, a material obtained by treating the surface of aluminum, copper, a copper alloy, or stainless steel with carbon, nickel, titanium, or silver is preferred, and aluminum, copper, a copper alloy, or stainless steel is more preferred.

Regarding the shape of the collector, generally, collectors having a film sheet-like shape are used, but it is also possible to use net-shaped collectors, punched collectors, compacts of lath bodies, porous bodies, foaming bodies, or fiber groups, and the like.

The thickness of the collector is not particularly limited, but is preferably 1 to 500 μm. In addition, the surface of the collector is preferably provided with protrusions and recesses by means of a surface treatment.

In the present invention, a functional layer, member, or the like may be appropriately interposed or disposed between the respective layers of the negative electrode collector, the negative electrode active material layer, the solid electrolyte layer, the positive electrode active material layer, and the positive electrode collector or on the outside thereof. In addition, the respective layers may be composed of a single layer or multiple layers.

[Chassis]

It is possible to produce the basic structure of the all-solid state secondary battery by disposing the respective layers described above. Depending on the use, the basic structure may be directly used as an all-solid state secondary battery, but the basic structure may be used after being enclosed in an appropriate chassis in order to have a dry battery form. The chassis may be a metallic chassis or a resin (plastic) chassis. In a case in which a metallic chassis is used, examples thereof include an aluminum alloy chassis and a stainless-steel chassis. The metallic chassis is preferably classified into a positive electrode-side chassis and a negative electrode-side chassis and electrically connected to the positive electrode collector and the negative electrode collector respectively. The positive electrode-side chassis and the negative electrode-side chassis are preferably integrated by being joined together through a gasket for short circuit prevention.

[Manufacturing of Solid Electrolyte-Containing Sheet]

The solid electrolyte-containing sheet of the embodiment of the invention is obtained by forming a film of the solid electrolyte composition of the embodiment of the invention on a base material (possibly, through a different layer) (application and drying) and forming a solid electrolyte layer or an active material layer (applied and dried layer) on the base material.

With the above-described aspect, it is possible to produce a sheet for an all-solid state secondary battery which is a sheet having a base material and an applied and dried layer. Here, the applied and dried layer refers to a layer formed by applying the solid electrolyte composition of the embodiment of the invention and drying the dispersion media (B) and (C) (that is, a layer formed using the solid electrolyte composition of the embodiment of the invention and made of a composition obtained by removing the dispersion media from the solid electrolyte composition of the embodiment of the invention). Between a sheet for an all-solid state secondary battery produced from a solid electrolyte composition satisfying the regulation of the present invention and a sheet for an all-solid state secondary battery produced from a solid electrolyte composition containing a dispersion medium not satisfying the regulation of the present invention, a difference in the ion conductivity or the like appears. However, for any of sheets for an all-solid state secondary battery, a majority or all of dispersion media are dried and removed in a manufacturing stage. Therefore, it is technically difficult to analyze a structure or characteristics as a substance that causes the appearance of the above-described difference in sheets for an all-solid state secondary battery. Therefore, in the present invention, layers will be specified using a layer-forming process, thereby clarifying the invention and clarifying the differentiation from the related art.

Additionally, regarding steps such as application, it is possible to use a method described in the following section of the manufacturing of an all-solid state secondary battery.

Meanwhile, the solid electrolyte-containing sheet may also contain a dispersion medium as long as the battery performance is not affected. Specifically, the solid electrolyte-containing sheet may contain 1 ppm or more and 10,000 ppm or less of the dispersion medium of the total mass.

[All-Solid State Secondary Battery and Manufacturing of Electrode Sheet for all-Solid State Secondary Battery]

The all-solid state secondary battery and the electrode sheet for an all-solid state secondary battery can be manufactured using an ordinary method. Specifically, the all-solid state secondary battery and the electrode sheet for an all-solid state secondary battery can be manufactured by forming the respective layers described above using the solid electrolyte composition of the embodiment of the invention or the like. Hereinafter, the manufacturing method will be described in detail.

The all-solid state secondary battery of the embodiment of the invention can be manufactured using a method including (through) a step of applying the solid electrolyte composition of the embodiment of the invention onto a metal foil which serves as a collector and forming a coated film (film manufacturing).

For example, a solid electrolyte composition containing a positive electrode active material is applied as a material for a positive electrode (a composition for a positive electrode) onto a metal foil which is a positive electrode collector so as to form a positive electrode active material layer, thereby producing a positive electrode sheet for an all-solid state secondary battery. Next, a solid electrolyte composition for forming a solid electrolyte layer is applied onto the positive electrode active material layer so as to form a solid electrolyte layer. Furthermore, a solid electrolyte composition containing a negative electrode active material is applied as a material for a negative electrode (a composition for a negative electrode) onto the solid electrolyte layer so as to form a negative electrode active material layer. A negative electrode collector (a metal foil) is overlaid on the negative electrode active material layer, whereby it is possible to obtain an all-solid state secondary battery having a structure in which the solid electrolyte layer is sandwiched between the positive electrode active material layer and the negative electrode active material layer. A desired all-solid state secondary battery can be produced by enclosing the all-solid state secondary battery in a chassis as necessary.

In addition, it is also possible to manufacture an all-solid state secondary battery by carrying out the methods for forming the respective layers in a reverse order so as to form a negative electrode active material layer, a solid electrolyte layer, and a positive electrode active material layer on a negative electrode collector and overlaying a positive electrode collector thereon.

As another method, the following method can be exemplified. That is, a positive electrode sheet for an all-solid state secondary battery is produced as described above. In addition, a solid electrolyte composition containing a negative electrode active material is applied as a material for a negative electrode (a composition for a negative electrode) onto a metal foil which is a negative electrode collector so as to form a negative electrode active material layer, thereby producing a negative electrode sheet for an all-solid state secondary battery. Next, a solid electrolyte layer is formed on the active material layer in any one of these sheets as described above. Furthermore, the other one of the positive electrode sheet for an all-solid state secondary battery and the negative electrode sheet for an all-solid state secondary battery is laminated on the solid electrolyte layer so that the solid electrolyte layer and the active material layer come into contact with each other. An all-solid state secondary battery can be manufactured as described above.

As still another method, the following method can be exemplified. That is, a positive electrode sheet for an all-solid state secondary battery and a negative electrode sheet for an all-solid state secondary battery are produced as described above. In addition, separately from the positive electrode sheet for an all-solid state secondary battery and the negative electrode sheet for an all-solid state secondary battery, a solid electrolyte composition is applied onto a base material, thereby producing a solid electrolyte sheet for an all-solid state secondary battery consisting of a solid electrolyte layer. Furthermore, the positive electrode sheet for an all-solid state secondary battery and the negative electrode sheet for an all-solid state secondary battery are laminated together so as to sandwich the solid electrolyte layer that has been peeled off from the base material. An all-solid state secondary battery can be manufactured as described above.

An all-solid state secondary battery can be manufactured by combining the above-described forming methods. For example, a positive electrode sheet for an all-solid state secondary battery, a negative electrode sheet for an all-solid state secondary battery, and a solid electrolyte sheet for an all-solid state secondary battery are produced respectively. Next, a solid electrolyte layer peeled off from a base material is laminated on the negative electrode sheet for an all-solid state secondary battery and is then attached to the positive electrode sheet for an all-solid state secondary battery, whereby an all-solid state secondary battery can be manufactured. In this method, it is also possible to laminate the solid electrolyte layer on the positive electrode sheet for an all-solid state secondary battery and attach the solid electrolyte layer to the negative electrode sheet for an all-solid state secondary battery.

(Formation of Individual Layers (Film Formation))

The method for applying the solid electrolyte composition is not particularly limited and can be appropriately selected. Examples thereof include coating (preferably wet-type coating), spray coating, spin coating, dip coating, slit coating, stripe coating, and bar coating.

At this time, the solid electrolyte composition may be dried after being applied or may be dried after being applied to multiple layers. The drying temperature is not particularly limited. The lower limit is preferably 30° C. or higher, more preferably 60° C. or higher, and still more preferably 80° C. or higher, and the upper limit is preferably 300° C. or lower, more preferably 250° C. or lower, and still more preferably 200° C. or lower. In a case in which the compositions are heated in the above-described temperature range, it is possible to remove the dispersion medium and form a solid state. In addition, the temperature is not excessively increased, and the respective members of the all-solid state secondary battery are not impaired, which is preferable. Therefore, in the all-solid state secondary battery, excellent total performance is exhibited, and it is possible to obtain a favorable binding property.

After the production of the applied solid electrolyte composition or the all-solid state secondary battery, the respective layers or the all-solid state secondary battery is preferably pressurized. In addition, the respective layers are also preferably pressurized in a state of being laminated together. Examples of the pressurization method include a hydraulic cylinder pressing machine and the like. The welding pressure is not particularly limited, but is, generally, preferably in a range of 50 to 1,500 MPa.

In addition, the applied solid electrolyte composition may be heated at the same time as pressurization. The heating temperature is not particularly limited, but is generally in a range of 30° C. to 300° C. The respective layers or the all-solid state secondary battery can also be pressed at a temperature higher than the glass transition temperature of the inorganic solid electrolyte.

The pressurization may be carried out in a state in which the applied solvent or dispersion medium has been dried in advance or in a state in which the solvent or the dispersion medium remains.

Meanwhile, the respective compositions may be applied at the same time, and the application, the drying, and the pressing may be carried out simultaneously and/or sequentially. The respective compositions may be applied to separate base materials and then laminated by means of transfer.

The atmosphere during the pressurization is not particularly limited and may be any one of in the atmosphere, under the dried air (the dew point: −20° C. or lower), in an inert gas (for example, in an argon gas, in a helium gas, or in a nitrogen gas), and the like.

The pressing time may be a short time (for example, within several hours) at a high pressure or a long time (one day or longer) under the application of an intermediate pressure. In the case of members other than the sheet for an all-solid state secondary battery, for example, the all-solid state secondary battery, it is also possible to use a restraining device (screw fastening pressure or the like) of the all-solid state secondary battery in order to continuously apply an intermediate pressure.

The pressing pressure may be a pressure that is constant or varies with respect to a portion under pressure such as a sheet surface.

The pressing pressure can be changed depending on the area or film thickness of the portion under pressure. In addition, it is also possible to change the same portion with a pressure that varies stepwise.

A pressing surface may be flat or roughened.

(Initialization)

The all-solid state secondary battery manufactured as described above is preferably initialized after the manufacturing or before the use. The initialization is not particularly limited, and it is possible to initialize the all-solid state secondary battery by, for example, carrying out initial charging and discharging in a state in which the pressing pressure is increased and then releasing the pressure up to a pressure at which the all-solid state secondary battery is ordinarily used.

[Usages of all-Solid State Secondary Battery]

The all-solid state secondary battery of the embodiment of the invention can be applied to a variety of usages. Application aspects are not particularly limited, and, in the case of being mounted in electronic devices, examples thereof include notebook computers, pen-based input personal computers, mobile personal computers, e-book players, mobile phones, cordless phone handsets, pagers, handy terminals, portable faxes, mobile copiers, portable printers, headphone stereos, video movies, liquid crystal televisions, handy cleaners, portable CDs, mini discs, electric shavers, transceivers, electronic notebooks, calculators, portable tape recorders, radios, backup power supplies, memory cards, and the like. Additionally, examples of consumer usages include automobiles (electric vehicles and the like), electric vehicles, motors, lighting equipment, toys, game devices, road conditioners, watches, strobes, cameras, medical devices (pacemakers, hearing aids, shoulder massage devices, and the like), and the like. Furthermore, the all-solid state secondary battery can be used for a variety of military usages and universe usages. In addition, the all-solid state secondary battery can also be combined with solar batteries.

According to the preferred embodiment of the present invention, individual application forms as described below are derived.

[1] All-solid state secondary batteries in which at least one layer of a positive electrode active material layer, a solid electrolyte layer, or a negative electrode active material layer contains a lithium salt.

[2] Methods for manufacturing an all-solid state secondary battery in which a solid electrolyte layer is formed by applying a slurry including a lithium salt and a sulfide-based inorganic solid electrolyte dispersed using the dispersion medium (B) and the dispersion medium (C) in a wet manner.

[3] Solid electrolyte compositions containing an active material for producing the all-solid state secondary battery.

[4] Electrode sheets for a battery obtained by applying the solid electrolyte composition onto a metal foil to form a film.

[5] Methods for manufacturing an electrode sheet for a battery in which the solid electrolyte composition is applied onto a metal foil, thereby forming a film.

As described in the preferred embodiments [2] and [5], preferred methods for manufacturing the all-solid state secondary battery and the electrode sheet for a battery are all wet-type processes. Therefore, even in a region in at least one layer of the positive electrode active material layer or the negative electrode active material layer in which the content of the inorganic solid electrolyte is as low as 10% by mass or less, the adhesiveness between the active material and the inorganic solid electrolyte, an efficient ion conduction path can be maintained, and it is possible to manufacture an all-solid state secondary battery having a high energy density (Wh/kg) and a high output density (W/kg) per battery mass.

All-solid state secondary batteries refer to secondary batteries having a positive electrode, a negative electrode, and an electrolyte which are all composed of solid. In other words, all-solid state secondary batteries are differentiated from electrolytic solution-type secondary batteries in which a carbonate-based solvent is used as an electrolyte. Among these, the present invention is assumed to be an inorganic all-solid state secondary battery. All-solid state secondary batteries are classified into organic (polymer) all-solid state secondary batteries in which a polymer compound such as polyethylene oxide is used as an electrolyte and inorganic all-solid state secondary batteries in which the Li—P—S-based glass, LLT, LLZ, or the like is used. Meanwhile, the application of organic compounds to inorganic all-solid state secondary batteries is not inhibited, and organic compounds can also be applied as binders or additives of positive electrode active materials, negative electrode active materials, and inorganic solid electrolytes.

Inorganic solid electrolytes are differentiated from electrolytes in which the above-described polymer compound is used as an ion conductive medium (polymer electrolyte), and inorganic compounds serve as ion conductive media. Specific examples thereof include the Li—P—S-based glass, LLT, and LLZ. Inorganic solid electrolytes do not emit positive ions (Li ions) and exhibit an ion transportation function. In contrast, there are cases in which materials serving as an ion supply source which is added to electrolytic solutions or solid electrolyte layers and emits positive ions (Li ions) are referred to as electrolytes; however, in the case of being differentiated from electrolytes as the ion transportation materials, the materials are referred to as “electrolyte salts” or “supporting electrolytes”. Examples of the electrolyte salts include LiTFSI.

In the present invention, “compositions” refer to mixtures obtained by uniformly mixing two or more components. Here, compositions may partially include agglomeration or uneven distribution as long as the compositions substantially maintain uniformity and exhibit desired effects.

### EXAMPLES

Hereinafter, the present invention will be described in more detail on the basis of examples. Meanwhile, the present invention is not interpreted to be limited thereto. “Parts” and “%” that represent compositions in the following examples are mass-based unless particularly otherwise described.

Meanwhile, “-” used in tables indicates the fact that a composition of a corresponding examples is not contained. In addition, “room temperature” refers to 25° C.

### EXAMPLES AND COMPARATIVE EXAMPLES

<Synthesis of Binder B-1 (Preparation of Binder B-1 Dispersionic Liquid)>

Heptane (200 parts by mass) was added to a 1 L three-neck flask equipped with a reflux cooling pipe and a gas introduction cock, nitrogen gas was introduced thereinto at a flow rate of 200 mL/min for 10 minutes, and heptane was heated to 80° C. A liquid prepared in a separate container (a liquid obtained by mixing butyl acrylate (manufactured by Wako Pure Chemical Industries, Ltd.) (110 parts by mass), methyl methacrylate (manufactured by Wako Pure Chemical Industries, Ltd.) (30 parts by mass), acrylic acid (manufactured by Wako Pure Chemical Industries, Ltd.) (10 parts by mass), a macromonomer MMC-1 (60 parts by mass in terms of the solid content amount), and a polymerization initiator V-601 (trade name, manufactured by Wako Pure Chemical Industries, Ltd.) (2.0 parts by mass) was added dropwise thereto for two hours, and then stirred at 80° C. for two hours. After that, V-601 (1.0 g) was added to the obtained mixture, and, furthermore, the components were stirred at 90° C. for two hours. The obtained solution was diluted with heptane, thereby obtaining a dispersionic liquid of a binder B-1 that was a polymer particle. The binder B-1 is represented by the following chemical formula. The concentration of the solid content was 34.8%, and the mass-average molecular weight was 123,000.

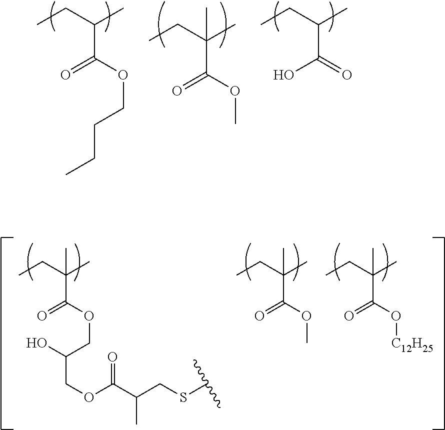

(Synthesis of Macromonomer MMC-1)

Toluene (190 parts by mass) was added to a 1 L three-neck flask equipped with a reflux cooling pipe and a gas introduction cock, nitrogen gas was introduced thereinto at a flow rate of 200 mL/min for 10 minutes, and then toluene was heated to 90° C. A liquid prepared in a separate container (the following formulation γ) was added dropwise to the toluene under stirring for two hours and then was stirred at 90° C. for two hours. After that, V-601 (manufactured by Wako Pure Chemical Industries, Ltd.) (0.2 parts by mass) was added thereto, and furthermore, the components were stirred at 100° C. for two hours. 2,2,6,6,-Tetramethyl piperidine-1-oxyl (manufactured by Tokyo Chemical Industry Co., Ltd.) (0.05 parts by mass), glycidyl methacrylate (manufactured by Wako Pure Chemical Industries, Ltd.) (100 parts by mass), and tetrabutyl ammonium bromide (manufactured by Tokyo Chemical Industry Co., Ltd.) (30 parts by mass) were added to the solution held at 100° C. after stirring and stirred at 120° C. for three hours. The obtained mixture was cooled to room temperature, added to methanol, and precipitated, and the precipitate was filtered, washed with methanol twice, and then dissolved by adding heptane (300 parts by mass) to the precipitate. The obtained solution was condensed by decompression, thereby obtaining a solution of the macromonomer MMC-1. The concentration of the solid content was 45.4% and the mass-average molecular weight was 5,300.

(Formula γ)

| | |
|---|---|
| Dodecyl methacrylate (manufactured by Wako Pure | 150 parts by mass |
| Chemical Industries, Ltd.) | |
| Methyl methacrylate (manufactured by Wako Pure | 59 parts by mass |
| Chemical Industries, Ltd.) | |
| 3-Mercaptobutyric acid (manufactured by Tokyo | 2 parts by mass |
| Chemical Industry Co., Ltd.) | |
| V-601 (manufactured by Wako Pure Chemical | 2.1 parts by mass |
| Industries, Ltd.) | |

—Measurement Method—

<Method for Measuring Concentration of Solid Content>

The concentrations of the solid contents of the dispersionic liquid of the binder B-1 and the macromonomer solution were measured on the basis of the following method.

Approximately 1.5 g of the dispersionic liquid of the binder B-1 or the macromonomer solution was weighed in an aluminum cup (7 cmϕ), and the weighed value was scanned to the three decimal places. Subsequently, the dispersionic liquid of the binder or the macromonomer solution was heated at 90° C. for two hours and, subsequently, 140° C. for two hours in a nitrogen atmosphere and dried. The mass of the obtained residue in the aluminum cup was measured, and the concentration of the solid content was computed using the following equation. The mass was measured five times, and the average of three measured masses excluding the maximum value and the minimum value was employed.

Concentration of solid content(%)=amount of residue in aluminum cup (g)/dispersionic liquid of binder B-1 or macromonomer solution (g)

<Measurement of Mass-Average Molecular Weight>

The mass-average molecular weight of the macromonomer forming the polymer particle was measured using the following method (condition 2).

<Synthesis of Sulfide-Based Inorganic Solid Electrolyte>

As a sulfide-based inorganic solid electrolyte, Li—P—S-based glass was synthesized with reference to a non-patent document of T. Ohtomo, A. Hayashi, M. Tatsumisago, Y. Tsuchida, S. HamGa, K. Kawamoto, Journal of Power Sources, 233, (2013), pp. 231 to 235 and A. Hayashi, S. Hama, H. Morimoto, M. Tatsumisago, T. Minami, Chem. Lett., (2001), pp. 872 and 873.

Specifically, in a globe box under an argon atmosphere (dew point: −70° C.), lithium sulfide (Li₂S, manufactured by Aldrich-Sigma, Co. LLC. Purity: >99.98%) (2.42 g) and diphosphorus pentasulfide (P₂S₅, manufactured by Aldrich-Sigma, Co. LLC. Purity: >99%) (3.90 g) were respectively weighed, injected into a mortar. The molar ratio between Li₂S and P₂S₅ was set to 75:25. The components were mixed on an agate mortar using an agate muddler for five minutes.

Zirconia beads having a diameter of 5 mm (66 g) were injected into a 45 mL zirconia container (manufactured by Fritsch Japan Co., Ltd.), the full amount of the mixture was injected thereinto, and the container was sealed in an argon atmosphere. The container was set in a planetary ball mill P-7 (trade name) manufactured by Fritsch Japan Co., Ltd., mechanical milling was carried out at 25° C. and a rotation speed of 510 rpm for 20 hours, thereby obtaining yellow powder (6.20 g) of a sulfide-based inorganic solid electrolyte (Li—P—S-based glass, LPS). The volume-average particle diameter was 15 μm.

<Method for Measuring Volume-Average Particle Diameter>

(Measurement of Volume-Average Particle Diameter of Inorganic Solid Electrolyte Before Addition to Solid Electrolyte Composition)

Using a dynamic light scattering-type particle size distribution measurement instrument according to JIS 8826:2005 (manufactured by Horiba Ltd., trade name: LB-500), the sulfide-based inorganic solid electrolyte particles synthesized above were split into a 20 ml sample bottle as a sample and diluted and adjusted using toluene so that a solid content concentration reached 0.2% by mass, data capturing was carried out 50 times using a 2 ml silica cell for measurement at a temperature of 25° C., and the obtained volume-based arithmetic average was considered as the average particle diameter. In addition, a particle diameter at 50% in the cumulative particle size distribution from the fine particle side was considered as the cumulative 50% particle diameter. The average particle diameter of the sulfide-based inorganic solid electrolyte particles before mixing was measured using the above-described method.

<Preparation of Solid Electrolyte Composition S-2>

One hundred and eighty zirconia beads having a diameter of 5 mm were injected into a 45 mL zirconia container (manufactured by Fritsch Japan Co., Ltd.), and the above-synthesized LPS (4.95 g), the binder B-1 (0.05 g in terms of the solid component mass), and the dispersion medium (B) and the dispersion medium (C) (at a mass ratio shown in Table 1 in a total amount of 17.0 g) were injected thereinto. After that, this container was set in a planetary ball mill P-7 manufactured by Fritsch Japan Co., Ltd., and the components were continuously mixed at a temperature of 25° C. and a rotation speed of 300 rpm for two hours, thereby obtaining a solid electrolyte composition S-2.

<Method for Measuring Volume-Average Particle Diameter>

(Measurement of Volume-Average Particle Diameter of Inorganic Solid Electrolyte in Solid Electrolyte Composition)

Using a dynamic light scattering-type particle size distribution measurement instrument according to JIS 8826:2005 (manufactured by Horiba Ltd., trade name: LB-500), the solid electrolyte composition was split into a 20 ml sample bottle as a sample and diluted and adjusted using toluene so that a solid content concentration reached 0.2% by mass. For this diluted liquid, data capturing was carried out 50 times using a 2 ml silica cell for measurement at a temperature of 25° C., and the obtained volume-based arithmetic average was considered as the average particle diameter. In addition, a particle diameter at 50% in the cumulative particle size distribution from the particle side was considered as the cumulative 50% particle diameter. The average particle diameter of the inorganic solid electrolyte particles in the solid electrolyte composition was measured using this method. The average particle diameters of the inorganic solid electrolyte particles in the solid electrolyte compositions are summarized in the column of the average particle diameter of Table 1.

Solid electrolyte compositions S-1, S-3 to S-14 and T-1 to T-5 were prepared in the same manner as the solid electrolyte composition S-2 except for the fact that the compositions were changed as shown in Table 1.

A solid electrolyte composition S-15 was obtained in the same manner as the solid electrolyte composition S-2 except for the fact, as shown in Table 1, N,N-diethyl-N-methyl-N-(2-methoxyethyl)ammonium bis(trifluoromethanesulfonyl)imide (ionic liquid) (0.10 g) and lithium bistrifluoromethanesulfonylimide (lithium salt) (0.05 g) were used in addition to the inorganic solid electrolyte, the binder, the dispersion medium (B), and the dispersion medium (C).

A solid electrolyte composition S-16 was obtained in the same manner as the solid electrolyte composition S-2 except for the fact, as shown in Table 1, N-propyl-N-methylpyrrolidinium bis(trifluoromethanesulfonyl)imide (ionic liquid) (0.10 g) and lithium bistrifluoromethanesulfonylimide (lithium salt) (0.05 g) were used in addition to the inorganic solid electrolyte, the binder, the dispersion medium (B), and the dispersion medium (C).

A solid electrolyte composition S-17 was obtained in the same manner as the solid electrolyte composition S-2 except for the fact, as shown in Table 1, lithium bistrifluoromethanesulfonylimide (lithium salt) (0.10 g) was used in addition to the inorganic solid electrolyte, the binder, the dispersion medium (B), and the dispersion medium (C).

TABLE 1

| | | | | | | | | | | | Boling | | | | |
|---|---|---|---|---|---|---|---|---|---|---|---|---|---|---|---|
| | | | | | Dis- | | | Dis- | | | point dif- | | | | |
| | | | | | per- | | Boil- | per- | | Boil- | ference | | | | |
| | Inorganic solid | | | | sion | | ing | sion | | ing | (° C.) | Mass | | | |
| | electrolyte | | Binder | | me- | Log P | point | me- | Log P | point | between | ratio | | | |
| | | % by | | % by | dium | value | of (B) | dium | value | of (C) | (B) and | (C)/ | Ionic | Li | |
| No. | | mass | | mass | (B) | of (B) | (° C.) | (C) | of (C) | (° C.) | (C) | (B) | liquid | salt | Note |
| S-1 | LPS | 100% | — | — | Acetone | 0.2 | 56 | Heptane | 3.42 | 98 | 42 | 200 | — | — | Present |
| | | | | | | | | | | | | | | | invention |
| S-2 | LPS | 99% | B-1 | 1% | Acetone | 0.2 | 56 | Heptane | 3.42 | 98 | 42 | 200 | — | — | Present |
| | | | | | | | | | | | | | | | invention |
| S-3 | LPS | 99% | HSBR | 1% | Acetone | 0.2 | 56 | Heptane | 3.42 | 98 | 42 | 200 | — | — | Present |
| | | | | | | | | | | | | | | | invention |
| S-4 | LPS | 99% | B-1 | 1% | THF | 0.4 | 66 | Heptane | 3.42 | 98 | 32 | 200 | — | — | Present |
| | | | | | | | | | | | | | | | invention |
| S-5 | LPS | 99% | B-1 | 1% | Pyridine | 0.7 | 115 | Heptane | 3.42 | 98 | −17 | 200 | — | — | Present |
| | | | | | | | | | | | | | | | invention |
| S-6 | LPS | 99% | B-1 | 1% | Pyridine | 0.7 | 115 | Toluene | 2.52 | 111 | −4 | 200 | — | — | Present |
| | | | | | | | | | | | | | | | invention |
| S-7 | LPS | 99% | B-1 | 1% | Pyridine | 0.7 | 115 | Nonane | 4.25 | 151 | 36 | 200 | — | — | Present |
| | | | | | | | | | | | | | | | invention |
| S-8 | LPS | 99% | B-1 | 1% | Pyridine | 0.7 | 115 | Heptane | 3.42 | 98 | −17 | 10000 | — | — | Present |
| | | | | | | | | | | | | | | | invention |
| S-9 | LPS | 99% | B-1 | 1% | Pyridine | 0.7 | 115 | Heptane | 3.42 | 98 | −17 | 10 | — | — | Present |
| | | | | | | | | | | | | | | | invention |
| S-10 | LPS | 99% | B-1 | 1% | PN | 0.82 | 97 | Heptane | 3.42 | 98 | 1 | 200 | — | — | Present |
| | | | | | | | | | | | | | | | invention |
| S-11 | LPS | 99% | B-1 | 1% | MEK | 0.86 | 80 | Heptane | 3.42 | 98 | 18 | 200 | — | — | Present |
| | | | | | | | | | | | | | | | invention |
| S-12 | LPS | 99% | B-1 | 1% | Pyrrole | 0.52 | 129 | Heptane | 3.42 | 98 | −31 | 200 | — | — | Present |
| | | | | | | | | | | | | | | | invention |
| S-13 | LPS | 99% | B-1 | 1% | Butanol | 0.97 | 108 | Heptane | 3.42 | 98 | −10 | 200 | — | — | Present |
| | | | | | | | | | | | | | | | invention |
| S-14 | LPS | 99% | B-1 | 1% | Ethanol | 0.07 | 78 | Heptane | 3.42 | 98 | 20 | 200 | — | — | Present |
| | | | | | | | | | | | | | | | invention |
| S-15 | LPS | 99% | B-1 | 1% | Acetone | 0.2 | 56 | Heptane | 3.42 | 98 | 42 | 200 | DEME | LiTFSI | Present |
| | | | | | | | | | | | | | | | invention |
| S-16 | LPS | 99% | B-1 | 1% | Acetone | 0.2 | 56 | Heptane | 3.42 | 98 | 42 | 200 | PMP | LiTFSI | Present |
| | | | | | | | | | | | | | | | invention |
| S-17 | LPS | 99% | B-1 | 1% | Tetra- | −0.53 | 276 | Toluene | 2.52 | 111 | 165 | 200 | — | LiTFSI | Present |
| | | | | | glyme | | | | | | | | | | invention |
| T-1 | LPS | 99% | HSBR | 1% | Acetone | 0.2 | 56 | Heptane | 3.42 | 98 | 42 | 5 | — | — | Compar- |
| | | | | | | | | | | | | | | | ative |
| | | | | | | | | | | | | | | | Example |
| T-2 | LPS | 99% | HSBR | 1% | TEA | 1.26 | 90 | Heptane | 3.42 | 98 | 8 | 10 | — | — | Compar- |
| | | | | | | | | | | | | | | | ative |
| | | | | | | | | | | | | | | | Example |
| T-3 | LPS | 99% | HSBR | 1% | Ethanol | 0.07 | 78 | Heptane | 3.42 | 98 | 20 | 1 | — | — | Compar- |
| | | | | | | | | | | | | | | | ative |
| | | | | | | | | | | | | | | | Example |
| T-4 | LPS | 99% | HSBR | 1% | Ethanol | 0.07 | 78 | 1- | 0.97 | 118 | 40 | 10 | — | — | Compar- |
| | | | | | | | | Butanol | | | | | | | ative |
| | | | | | | | | | | | | | | | Example |
| T-5 | LPS | 99% | HSBR | 1% | TBA | 3.97 | 217 | Heptane | 3.42 | 98 | −119 | 10 | — | — | Compar- |
| | | | | | | | | | | | | | | | ative |
| | | | | | | | | | | | | | | | Example |

LPS: The sulfide-based inorganic solid electrolyte synthesized above
THF: Tetrahydrofuran
PN: Propionitrile
MEK: 2-Butanone
TEA: Triethylamine
TBA: Tri n-butylamine
HSBR: Hydrogenated styrene butadiene rubber (trade name DYNARON1321P manufactured by JSR Corporation) [in the composition, not particulate]
DEME: N,N-diethyl-N-methyl-N-(2-methoxyethyl)ammonium bis(trifluoromethanesulfonyl)imide
PMP: N-propyl-N-methylpyrrolidium bis(trifluorometahnesulfonyl)imide
LiTFSI: Lithium bistrifluoromethanesulfonylimide
B-1: The above-described binder

In some cases, the dispersion medium (B) and the dispersion medium (C) are simply expressed as (B) or (C) respectively.

In some of the comparative examples, for the comparison with the examples, dispersion media outside the respective specified ranges are shown in the column of the dispersion medium (B) or the dispersion medium (C).

Boiling point difference (° C.) between (B) and (C): boiling point of dispersion medium (C)-boiling point of dispersion medium (B)

Meanwhile, it was confirmed that the combinations of the dispersion media S-1 to S-13, S-15 to S-17, T-1 and T-2, and T-4 and T-5 were mixed evenly, but the combination of the dispersion media S-14 and T-3 was not mixed evenly.

<Evaluation of Dispersibility>

The solid electrolyte composition was added up to 10 cm in height to a 15 cm-high glass testing tube (10 mmϕ) and left to stand at 25° C. for 15 hours, and then the height of the separated supernatant was measured, thereby visually evaluating the dispersibility (dispersion stability) according to the following evaluation standards. Evaluation standards of “3” or higher are pass. The results are shown in Table 2.

—Evaluation Standards—

5: Height of supernatant/height of total amount <0.1

4: 0.1≤height of supernatant/height of total amount <0.3

3: 0.3≤height of supernatant/height of total amount <0.5

2: 0.5≤height of supernatant/height of total amount <0.7

1: 0.7≤height of supernatant/height of total amount

[Total amount: the total amount of the solid electrolyte composition that was a slurry, supernatant: a supernatant liquid generated by the sedimentation of the solid component of the solid electrolyte composition]

(Production Example of Solid Electrolyte Sheet for all-Solid State Secondary Battery)

Each of the solid electrolyte compositions obtained above was applied onto a 20 μm-thick aluminum foil using an applicator (trade name: SA-201 Baker type applicator, manufactured by Tester Sangyo Co., Ltd.) and heated at 80° C. for two hours, thereby drying the solid electrolyte composition. After that, the dried solid electrolyte composition was heated and pressurized at a temperature of 120° C. and a pressure of 600 MPa for 10 seconds using a heat pressing machine, thereby obtaining individual sold electrolyte sheets for an all-solid state secondary battery Nos. 101 to 117 and c11 to c15. The film thickness of the solid electrolyte layer was 50 μm.

For the produced solid electrolyte sheets for an all-solid state secondary battery, the following tests were carried out, and the results are shown in Table 2.

<Measurement of Ion Conductivity>

A disc-shaped piece having a diameter of 14.5 mm was cut out from the solid electrolyte sheet for an all-solid state secondary battery obtained above, and this solid electrolyte sheet for an all-solid state secondary battery 12 was put into a coin case 11 illustrated in FIG. 2. Specifically, an aluminum foil cut out in a disc shape having a diameter of 15 mm (not illustrated in FIG. 2) was brought into contact with the solid electrolyte layer, a spacer and a washer (both are not illustrated in FIG. 2) were combined into the coin case, and the aluminum foil was put into the 2032-type stainless steel coin case 11. The coin case 11 was swaged, thereby producing a jig for ion conductivity measurement 13.

The ion conductivity was measured using the above-obtained jig for ion conductivity measurement. Specifically, alternating current impedance was measured in a constant-temperature tank (30° C.) using a 1255B FREQUENCY RESPONSE ANALYZER (trade name) manufactured by Solartron Analytical. Inc. at a voltage magnitude of 5 mV and wavelengths of 1 MHz to 1 Hz. Therefore, the resistance of a specimen in the film thickness direction was obtained, and the resistance was obtained by means of calculation using Expression (1).

Ion conductivity (mS/cm)=1,000×specimen film thickness (cm)/(resistance(Ω)×specimen area (cm²)) Expression (1)

<Evaluation of Binding Property>

A disc-shaped piece having a diameter of 15 mm was cut out from the solid electrolyte sheet for an all-solid state secondary battery, and a surface portion (observation region: 500 μm×500 μm) of the solid electrolyte layer in the cut-out sheet was observed using an optical microscope for inspection (ECLIPSE Ci (trade name), manufactured by Nikon Corporation), thereby evaluating the presence and absence of chips, breakages, or cracks in the solid electrolyte layer and the presence and absence of the peeling of the solid electrolyte layer from the aluminum foil (collector) according to the following evaluation standards. Evaluation standards of “2” or higher are pass. The results are shown in Table 2.

—Evaluation Standards—

5: Defects (chips, breakages, cracks, or peels) were not observed.

4: The area of a defect portion occupied more than 0% and 20% or less of the entire area that was the observation subject.

3: The area of a defect portion occupied more than 20% and 40% or less of the entire area that was the observation subject.

2: The area of a defect portion occupied more than 40% and 70% or less of the entire area that was the observation subject.

1: The area of a defect portion occupied more than 70% of the entire area that was the observation subject.

TABLE 2

| | Solid | | Ion | | |
|---|---|---|---|---|---|
| | electrolyte | Binding | conductivity | | |
| No. | layer | property | (mS/cm) | Dispersibility | Note |
| 101 | S-1 | 2 | 0.43 | 3 | Present |
| | | | | | invention |
| 102 | S-2 | 5 | 0.4 | 5 | Present |
| | | | | | invention |
| 103 | S-3 | 5 | 0.15 | 4 | Present |
| | | | | | invention |
| 104 | S-4 | 5 | 0.4 | 5 | Present |
| | | | | | invention |
| 105 | S-5 | 5 | 0.35 | 5 | Present |
| | | | | | invention |
| 106 | S-6 | 5 | 0.36 | 5 | Present |
| | | | | | invention |
| 107 | S-7 | 5 | 0.45 | 5 | Present |
| | | | | | invention |
| 108 | S-8 | 5 | 0.33 | 3 | Present |
| | | | | | invention |
| 109 | S-9 | 4 | 0.3 | 5 | Present |
| | | | | | invention |
| 110 | S-10 | 5 | 0.31 | 4 | Present |
| | | | | | invention |
| 111 | S-11 | 5 | 0.32 | 5 | Present |
| | | | | | invention |
| 112 | S-12 | 5 | 0.35 | 5 | Present |
| | | | | | invention |
| 113 | S-13 | 5 | 0.28 | 4 | Present |
| | | | | | invention |
| 114 | S-14 | 4 | 0.18 | 4 | Present |
| | | | | | invention |
| 115 | S-15 | 5 | 0.47 | 5 | Present |
| | | | | | invention |
| 116 | S-16 | 5 | 0.46 | 5 | Present |
| | | | | | invention |
| 117 | S-17 | 5 | 0.4 | 5 | Present |
| | | | | | invention |
| c11 | T-1 | 4 | 0.07 | 1 | Comparative |
| | | | | | Example |
| c12 | T-2 | 4 | 0.1 | 2 | Comparative |
| | | | | | Example |
| c13 | T-3 | 4 | 0.04 | 1 | Comparative |
| | | | | | Example |
| c14 | T-4 | 4 | 0.02 | 1 | Comparative |
| | | | | | Example |
| c15 | T-5 | 4 | 0.18 | 1 | Comparative |
| | | | | | Example |

<Preparation of Composition for Positive Electrode U-1>

One hundred and eighty zirconia beads having a diameter of 5 mm were injected into a 45 mL zirconia container (manufactured by Fritsch Japan Co., Ltd.), and LPS (2.9 g), the binder B-1 (0.1 g in terms of the solid content), and the dispersion medium (B) and the dispersion medium (C) at a mass ratio shown in Table 3 in a total amount of 22 g were injected thereinto. After that, the container was set in a planetary ball mill P-7 (trade name) manufactured by Fritsch Japan Co., Ltd., and the components were stirred at a temperature of 25° C. and a rotation speed of 300 rpm for two hours. After that, NMC (manufactured by Nippon Chemical Industrial Co., Ltd.) (7.0 g) was injected thereinto as an active material, similarly, the container was set in the planetary ball mill P-7, and the components were continuously mixed together at a temperature of 25° C. and a rotation speed of 100 rpm for 15 minutes, thereby obtaining a composition for a positive electrode U-1.

Compositions for a positive electrode U-2 to U-10 and V-1 to V-5 were prepared in the same manner as the composition for a positive electrode U-1 except for the fact that the compositions were changed as shown in Table 3.

A composition for a positive electrode U-11 was obtained in the same manner as the composition for a positive electrode U-1 except for the fact, as shown in Table 3, N,N-diethyl-N-methyl-N-(2-methoxyethyl)ammonium bis(trifluoromethanesulfonyl)imide (ionic liquid) (0.20 g) and lithium bistrifluoromethanesulfonylimide (lithium salt) (0.10 g) were used in addition to the positive electrode active material, the inorganic solid electrolyte, the binder, the dispersion medium (B), and the dispersion medium (C). The ionic liquid and the lithium salt were added thereto before being stirred at 300 rpm for two hours.

A composition for a positive electrode U-12 was obtained in the same manner as the composition for a positive electrode U-1 except for the fact, as shown in Table 3, N-propyl-N-methylpyrrolidinium bis(trifluoromethanesulfonyl)imide (ionic liquid) (0.20 g) and lithium bistrifluoromethanesulfonylimide (lithium salt) (0.10 g) were used in addition to the positive electrode active material, the inorganic solid electrolyte, the binder, the dispersion medium (B), and the dispersion medium (C). The ionic liquid and the lithium salt were added thereto before being stirred at 300 rpm for two hours.

A composition for a positive electrode U-13 was obtained in the same manner as the composition for a positive electrode U-1 except for the fact, as shown in Table 3, lithium bistrifluoromethanesulfonylimide (lithium salt) (0.20 g) was added thereto in addition to the positive electrode active material, the inorganic solid electrolyte, the binder, the dispersion medium (B), and the dispersion medium (C). The lithium salt was added thereto before being stirred at 300 rpm for two hours.

A composition for a positive electrode U-14 was obtained in the same manner as the composition for a positive electrode U-1 except for the fact, as shown in Table 3, N,N-diethyl-N-methyl-N-(2-methoxyethyl)ammonium bis(trifluoromethanesulfonyl)imide (lithium salt) (0.20 g), lithium bistrifluoromethanesulfonylimide (lithium salt) (0.10 g), and acetylene black (conductive auxiliary agent) (0.50 g) were added thereto in addition to the positive electrode active material, the inorganic solid electrolyte, the binder, the dispersion medium (B), and the dispersion medium (C). The ionic liquid, the lithium salt, and the conductive auxiliary agent were added thereto before being stirred at 300 rpm for two hours.

The compositions for a positive electrode U-1 to U-14 are the solid electrolyte composition of the embodiment of the invention, and the compositions for a positive electrode V-1 to V-5 are comparative solid electrolyte compositions.

TABLE 3

| | | | | | | | | Log P | | Log P | | | | |
|---|---|---|---|---|---|---|---|---|---|---|---|---|---|---|
| | Positive electrode | | Inorganic solid | | | | Dis- | value of | Dis- | value of | | | | |
| | active material | | electrolyte | | Binder | | persion | dispersion | persion | dispersion | Mass | | | Conduc- |
| | | % by | | % by | | % by | medium | medium | medium | medium | ratio | Ionic | Li | tive auxil- |
| No. | | mass | | mass | | mass | (B) | (B) | (C) | (C) | (C)/(B) | liquid | salt | iary agent |
| U-1 | NMC | 70 | LPS | 29 | B-1 | 1 | Acetone | 0.2 | Heptane | 3.42 | 200 | — | — | — |
| U-2 | NMC | 70 | LPS | 29 | HSBR | 1 | Acetone | 0.2 | Heptane | 3.42 | 200 | — | — | — |
| U-3 | LCO | 70 | LPS | 29 | B-1 | 1 | Acetone | 0.2 | Heptane | 3.42 | 200 | — | — | — |
| U-4 | NMC | 70 | LPS | 29 | B-1 | 1 | THF | 0.4 | Heptane | 3.42 | 200 | — | — | — |
| U-5 | NMC | 70 | LPS | 29 | B-1 | 1 | Pyridine | 0.7 | Heptane | 3.42 | 200 | — | — | — |
| U-6 | NMC | 70 | LPS | 29 | B-1 | 1 | Pyridine | 0.7 | Nonane | 4.25 | 200 | — | — | — |
| U-7 | NMC | 70 | LPS | 29 | B-1 | 1 | Pyridine | 0.7 | Heptane | 3.42 | 10000 | — | — | — |
| U-8 | NMC | 70 | LPS | 29 | B-1 | 1 | Pyridine | 0.7 | Heptane | 3.42 | 10 | — | — | — |
| U-9 | NMC | 70 | LPS | 29 | B-1 | 1 | Pyrrole | 0.52 | Heptane | 3.42 | 200 | — | — | — |
| U-10 | NMC | 70 | LPS | 29 | B-1 | 1 | Ethanol | 0.07 | Heptane | 3.42 | 200 | — | — | — |
| U-11 | NMC | 70 | LPS | 29 | B-1 | 1 | Acetone | 0.2 | Heptane | 3.42 | 200 | DEME | LiTFSI | — |
| U-12 | NMC | 70 | LPS | 29 | B-1 | 1 | Acetone | 0.2 | Heptane | 3.42 | 200 | PMP | LiTFSI | — |
| U-13 | NMC | 70 | LPS | 29 | B-1 | 1 | Tetraglyme | −0.53 | Toluene | 2.52 | 200 | — | LiTFSI | — |
| U-14 | NMC | 70 | LPS | 29 | B-1 | 1 | Acetone | 0.2 | Heptane | 3.42 | 200 | DEME | LiTFSI | AB |
| V-1 | NMC | 70 | LPS | 29 | HSBR | 1 | Acetone | 0.2 | Heptane | 3.42 | 5 | — | — | — |
| V-2 | NMC | 70 | LPS | 29 | HSBR | 1 | TEA | 1.26 | Heptane | 3.42 | 10 | — | — | — |
| V-3 | NMC | 70 | LPS | 29 | HSBR | 1 | Ethanol | 0.07 | Heptane | 3.42 | 1 | — | — | — |
| V-4 | NMC | 70 | LPS | 29 | HSBR | 1 | Ethanol | 0.07 | 1-Butanol | 0.97 | 10 | — | — | — |
| V-5 | NMC | 70 | LPS | 29 | HSBR | 1 | TBA | 3.97 | Heptane | 3.42 | 10 | — | — | — |

<Notes of table>
NMC: LiNi_{1/3}Co_{1/3}Mn_{1/3}O₂ (lithium nickel manganese cobalt oxide)
LCO: LiCoO₂ (lithium cobalt oxide)
LPS: The sulfide-based inorganic solid electrolyte synthesized above
B-1: The above-described synthesized binder
HSBR: Hydrogenated styrene butadiene rubber (trade name DYNARON1321P manufactured by JSR Corporation)
DEME: N,N-diethyl-N-methyl-N-(2-methoxyethyl)ammonium bis(trifluoromethanesulfonyl)imide
PMP: N-propyl-N-methylpyrrolidium bis(trifluorometahnesulfonyl)imide
LiTFSI: Lithium bistrifluoromethanesulfonylimide
AB: Acetylene black (manufactured by Denka Company Limited)
THF: Tetrahydrofuran
TEA: Triethylamine
TBA: Tributylamine

In some of V-1 to V-5, for the comparison with U-1 to U-10, dispersion media outside the respective specified ranges are shown in the column of the dispersion medium (B) or the dispersion medium (C).

<Production of Positive Electrode Sheet for all-Solid State Secondary Battery>

The composition for a positive electrode U-1 obtained above was applied onto a 20 μm-thick aluminum foil using a Baker type applicator (trade name: SA-201, manufactured by Tester Sangyo Co., Ltd.) and heated at 80° C. for two hours, thereby drying the composition for a positive electrode. After that, the dried composition for a positive electrode U-1 was pressurized (at 600 MPa for one minute) under heating (at 80° C.) so as to obtain a predetermined density, thereby producing a positive electrode sheet for an all-solid state secondary battery having a positive electrode active material layer having a film thickness of 80 μm.

Next, the solid electrolyte composition S-2 was applied onto the obtained positive electrode active material layer using the Baker type applicator and heated at 80° C. for two hours, thereby drying the solid electrolyte composition. After that, the dried solid electrolyte composition S-2 was pressurized (at 600 MPa for 10 seconds) under heating (at 80° C.) so as to obtain a predetermined density, thereby producing a positive electrode sheet for an all-solid state secondary battery having a solid electrolyte layer having a film thickness of 30 μm.

<Production of all-Solid State Secondary Battery>

A disc-shaped piece having a diameter of 14.5 mm was cut out from the positive electrode sheet for an all-solid state secondary battery obtained above, was put into a 2032-type stainless steel coin case 11 into which a spacer and a washer were combined, and an indium foil cut out to a diameter of 15 mm was overlaid on the solid electrolyte layer. A stainless steel foil was further overlaid on the indium foil, and the 2032-type coin case 11 was swaged, thereby producing all-solid state secondary batteries No. 201 illustrated in FIG. 2.

The all-solid state secondary battery manufactured as described above has a layer constitution illustrated in FIG. 1.

All-solid state secondary batteries Nos. 202 to 214 and c21 to c25 were produced in the same manner as the all-solid state secondary battery No. 201 except for the fact that the compositions for forming the positive electrode active material layer and the solid electrolyte layer were respectively changed to compositions shown in Table 4.

<Evaluation of Resistance>

The resistance of the all-solid state secondary battery produced above was evaluated using a charge and discharge evaluation device TOSCAT-3000 (trade name) manufactured by Toyo System Corporation. The all-solid state secondary battery was charged at a current density of 0.2 mA/cm² until the battery voltage reached 3.6 V. The all-solid state secondary battery was discharged at a current density of 0.1 mA/cm² until the battery voltage reached 2.5 V. The charging and discharge were repeated, the battery voltage after three cycles of 5 mAh/g (the quantity of electricity per gram of the weight of the active material) discharging was scanned using the following standards, and the resistance was evaluated. A higher battery voltage indicates a lower resistance. Evaluation standards of “3” or higher are pass. The results are shown in Table 4.

5: 3.4 V or higher

4: 3.2 V or higher and lower than 3.4 V

3: 2.9 V or higher and less than 3.2 V

2: Lower than 2.9 V

1: Charging and discharging was not possible.

<Evaluation of Discharge Capacity Retention (Cycle Characteristics)>

The discharge capacity retention of the all-solid state secondary battery produced above was measured using a charge and discharge evaluation device TOSCAT-3000 (trade name). The all-solid state secondary battery was charged at a current density of 0.1 mA/cm² until the battery voltage reached 3.6 V. The all-solid state secondary battery was discharged at a current density of 0.1 mA/cm² until the battery voltage reached 2.5 V. Three cycles of charging and discharging were repeated under the above-described conditions, thereby carrying out initialization. The discharge capacity at the first cycle after the initialization was considered as 100%, and the number of cycles repeated until the discharge capacity retention reached 80% was evaluated using the following standards. Evaluation standards of “3” or higher are pass. The results are shown in Table 4.

5: 200 cycles or more

4: 100 cycles or more and less than 200 cycles

3: 60 cycles or more and less than 100 cycles

2: 20 cycles or more and less than 60 cycles

1: Less than 20 cycles

TABLE 4

| | Layer constitution | | | | |
|---|---|---|---|---|---|
| | Positive | Solid | | | |
| | electrode | electrolyte | | Cycle | |
| No. | layer | layer | Resistance | characteristics | Note |
| 201 | U-1 | S-2 | 5 | 4 | Present |
| | | | | | invention |
| 202 | U-2 | S-3 | 3 | 4 | Present |
| | | | | | invention |
| 203 | U-3 | S-3 | 3 | 4 | Present |
| | | | | | invention |
| 204 | U-4 | S-4 | 5 | 4 | Present |
| | | | | | invention |
| 205 | U-5 | S-5 | 4 | 5 | Present |
| | | | | | invention |
| 206 | U-6 | S-7 | 5 | 5 | Present |
| | | | | | invention |
| 207 | U-7 | S-8 | 5 | 4 | Present |
| | | | | | invention |
| 208 | U-8 | S-9 | 4 | 4 | Present |
| | | | | | invention |
| 209 | U-9 | S-12 | 4 | 5 | Present |
| | | | | | invention |
| 210 | U-10 | S-14 | 3 | 3 | Present |
| | | | | | invention |
| 211 | U-11 | S-15 | 5 | 5 | Present |
| | | | | | invention |
| 212 | U-12 | S-16 | 5 | 5 | Present |
| | | | | | invention |
| 213 | U-13 | S-17 | 5 | 5 | Present |
| | | | | | invention |
| 214 | U-14 | S-2 | 5 | 5 | Present |
| | | | | | invention |
| c21 | V-1 | T-1 | 2 | 2 | Comparative |
| | | | | | Example |
| c22 | V-2 | T-2 | 2 | 1 | Comparative |
| | | | | | Example |
| c23 | V-3 | T-3 | 2 | 1 | Comparative |
| | | | | | Example |
| c24 | V-4 | T-4 | 2 | 1 | Comparative |
| | | | | | Example |
| c25 | V-5 | T-5 | 3 | 1 | Comparative |
| | | | | | Example |

As is clear from Table 4, all of the all-solid state secondary batteries for which the positive electrode layer and the solid electrolyte layer were formed using the solid electrolyte composition of the embodiment of the invention has a low battery resistance and excellent cycle characteristics. In contrast, the all-solid state secondary batteries produced without using the solid electrolyte composition of the embodiment of the invention failed in terms of the battery resistance and the cycle characteristics.

The present invention has been described together with the embodiment; however, unless particularly specified, the present inventors do not intend to limit the present invention to any detailed portion of the description and consider that the present invention is supposed to be broadly interpreted within the concept and scope of the present invention described in the claims.

### EXPLANATION OF REFERENCES

1: negative electrode collector
2: negative electrode active material layer
3: solid electrolyte layer
4: positive electrode active material layer
5: positive electrode collector
6: operation portion
10: all-solid state secondary battery
11: 2032-type coin case
12: sheet for all-solid state secondary battery
13: jig for ion conductivity measurement or all-solid state secondary battery

What is claimed is:

1. A solid electrolyte composition comprising:
an inorganic solid electrolyte (A) having conductivity of an ion of a metal belonging to Group I or II of a periodic table;
a dispersion medium (B) having a Log P value of 0.2 or more and 1.2 or less; and
a dispersion medium (C) having a Log P value of 2 or more,
wherein a mass ratio (C)/(B) of the dispersion medium (C) to the dispersion medium (B) is 100,000≥(C)/(B)≥10.

2. The solid electrolyte composition according to claim 1,
wherein the mass ratio (C)/(B) is 1,000≥(C)/(B)≥50.

3. The solid electrolyte composition according to claim 1,
wherein the dispersion medium (B) is a ketone compound, a nitrile compound, a halogen-containing compound, a heterocyclic compound in which a hetero atom constituting a ring is a nitrogen atom or a sulfur atom, or a carbonate compound.

4. The solid electrolyte composition according to claim 1,
wherein the dispersion medium (B) is a ketone compound, a heterocyclic compound in which a hetero atom constituting a ring is a nitrogen atom or a sulfur atom, or a halogen-containing compound, and the dispersion medium (C) is a hydrocarbon compound or an aromatic compound.

5. The solid electrolyte composition according to claim 1,
wherein the dispersion medium (B) is a heterocyclic compound in which a hetero atom constituting a ring is a nitrogen atom or a sulfur atom.

6. The solid electrolyte composition according to claim 1,
wherein the dispersion medium (B) and the dispersion medium (C) are evenly mixed together in the case of being mixed together at the mass ratio.

7. The solid electrolyte composition according to claim 1, further comprising:
a polymer particle (D).

8. The solid electrolyte composition according to claim 1,
wherein the inorganic solid electrolyte (A) is represented by Formula (1),
Lₐ₁M_{b1}P_{c1}S_{d1}Aₑ₁ Formula (1)
in the formula, L represents an element selected from Li, Na, and K, M represents an element selected from B, Zn, Sn, Si, Cu, Ga, Sb, Al, and Ge, A represents I, Br, Cl, or F, a1 to e1 represent compositional ratios of the respective elements, and a1:b1:c1:d1:e1 satisfies 1 to 12:0 to 5:1:2 to 12:0 to 10.

9. The solid electrolyte composition according to claim 7,
wherein the polymer particle (D) is insoluble in the dispersion medium (B) and the dispersion medium (C).

10. The solid electrolyte composition according to claim 1, further comprising:
an active material (E) capable of inserting and discharging the ion of the metal belonging to Group I or II of the periodic table.

11. The solid electrolyte composition according to claim 10,
wherein the active material (E) is a metal oxide.

12. The solid electrolyte composition according to claim 1, further containing:
a conductive auxiliary agent.

13. The solid electrolyte composition according to claim 1, further containing:
a lithium salt.

14. The solid electrolyte composition according to claim 1, further containing:
an ionic liquid.

15. A solid electrolyte-containing sheet comprising, on a base material:
an applied and dried layer of the solid electrolyte composition according to claim 1.

16. An electrode sheet for an all-solid state secondary battery, comprising, on a metal foil:
an applied and dried layer of the solid electrolyte composition according to claim 10.

17. An all-solid state secondary battery comprising:
a positive electrode active material layer;
a negative electrode active material layer; and
a solid electrolyte layer,
wherein at least one of the positive electrode active material layer, the negative electrode active material layer, or the solid electrolyte layer is an applied and dried layer of the solid electrolyte composition according to claim 1.

18. A method for manufacturing a solid electrolyte-containing sheet, comprising:
a step of disposing the solid electrolyte composition according to claim 1 on a base material and forming a coated film.

19. A method for manufacturing an electrode sheet for an all-solid state secondary battery, comprising:
a step of disposing the solid electrolyte composition according to claim 10 on a metal foil and forming a coated film.

20. A method for manufacturing an all-solid state secondary battery,
wherein an all-solid state secondary battery is manufactured through the manufacturing method according to claim 18.
